(19) United States
(12) Patent Application Publication
(10) Pub. No.: US 2026/0018109 A1
(43) Pub. Date: Jan. 15, 2026

(54) DRIVER, DISPLAY APPARATUS INCLUDING THE SAME AND ELECTRONIC APPARATUS INCLUDING THE SAME

(71) Applicant: Samsung Display Co., Ltd., Yongin-si (KR)

(72) Inventors: KYUNG-HOON KIM, Yongin-si (KR); Yongchan Kim, Yongin-si (KR); Jooyoung Chun, Yongin-si (KR)

(21) Appl. No.: 19/097,747

(22) Filed: Apr. 1, 2025

(30) Foreign Application Priority Data
Jul. 11, 2024 (KR) 10-2024-0091962

(51) Int. Cl. G09G 3/32

(52) U.S. Cl. CPC G09G 3/32; G09G 2300/0426; G09G 2300/0819; G09G 2300/0842; G09G 2300/0861; G09G 2310/0267; G09G 2310/0286; G09G 2310/08

(57) ABSTRACT

A driver includes a first transistor including a control electrode for receiving a clock signal, a first electrode for receiving an input signal, and a second electrode connected to a first node, a second transistor including a control electrode connected to the first node, a first electrode for receiving a first power voltage, and a second electrode connected to a second node, a third transistor for receiving a second power voltage, and connected to the first node and to a third node, a fourth transistor connected to the first and second nodes, a fifth transistor connected to the second node, for receiving the high power voltage, and connected to an output node, and a sixth transistor connected to the third and output nodes, and for receiving the low power voltage, the fourth transistor being an NMOS transistor, and a gate-source voltage of the fourth transistor being less than zero.

### CROSS-REFERENCE TO RELATED APPLICATION

The present application claims priority to, and the benefit of, Korean Patent Application No. 10-2024-0091962, filed on Jul. 11, 2024, in the Korean Intellectual Property Office, the entire disclosure of which is incorporated herein by reference.

### BACKGROUND

### 1. Field

Embodiments of the present disclosure may relate to a driver, a display apparatus including the driver and/or an electronic apparatus including the driver. For example, embodiments of the present disclosure may relate to a CMOS (complementary metal oxide semiconductor) type driver that may be used as a gate driver and/or an emission driver, a display apparatus including the driver and/or an electronic apparatus including the driver.

### 2. Description of the Related Art

A display apparatus may include a display panel and/or a display panel driver. The display panel may include a plurality of gate lines, a plurality of data lines, a plurality of emission lines and/or a plurality of pixels. The display panel driver may include a gate driver, a data driver, an emission driver and/or a driving controller. The gate driver may output gate signals to the gate lines. The data driver may output data voltages to the data lines. The emission driver may output emission signals to the emission lines. The driving controller may control the gate driver, the data driver and/or the emission driver.

A driver (e.g., the gate driver and/or the emission driver) of the display apparatus may output (e.g., sequentially output) signals (e.g., the gate signals and/or the emission signals) to the pixels of the display panel in a unit of a pixel row. The driver may be implemented to form (or provide) a shift register including a plurality of stages to output (e.g., sequentially output) the signals in a unit of the pixel row.

A current may be leaked at the NMOS (N-type Metal-Oxide Semiconductor) transistors, if the driver includes NMOS transistors. A reliability of the driver may be reduced (e.g., deteriorated), if the current is leaked at the NMOS transistors.

### SUMMARY

Embodiments of the present disclosure may provide a driver in which a gate-source voltage of an NMOS transistor is operated in a negative region, and may reduce a current leakage of the NMOS transistor.

Embodiments of the present inventive concept also provide a display apparatus including the driver.

Embodiments of the present inventive concept also provide an electronic apparatus including the driver.

In one or more embodiments of a driver, the driver includes a first transistor including a control electrode configured to receive a clock signal, a first electrode configured to receive an input signal, and a second electrode connected to a first node, a second transistor including a control electrode connected to the first node, a first electrode configured to receive a first voltage, and a second electrode connected to a second node, a third transistor including a control electrode configured to receive a second voltage, a first electrode connected to the first node, and a second electrode connected to a third node, a fourth transistor including an NMOS transistor including a control electrode connected to the first node, and a first electrode connected to the second node, and configured to have a gate-source voltage that is less than zero, a fifth transistor including a control electrode connected to the second node, a first electrode configured to receive the first voltage, and a second electrode connected to an output node, and a sixth transistor including a control electrode connected to the third node, a first electrode connected to the output node, and a second electrode configured to receive the second voltage.

The driver may further include a first capacitor including a first electrode connected to the third node, and a second electrode connected to the output node.

The driver may further include a second capacitor including a first electrode configured to receive the first voltage, and a second electrode connected to the second node, wherein the first voltage includes a high power voltage.

The first transistor, the second transistor, the third transistor, the fifth transistor, and the sixth transistor may include PMOS transistors.

The fourth transistor may further include a second control electrode connected to the control electrode of the fourth transistor.

The fourth transistor may further include a second electrode configured to receive a third voltage, wherein the second voltage includes a low power voltage, and wherein the third voltage includes another low power voltage that is different from the second voltage.

The third voltage may be greater than the second voltage.

The driver may further include an eighth transistor including a control electrode connected to the third node, and a first electrode connected to the first node, wherein the fourth transistor further includes a second electrode configured to receive the second voltage.

The eighth transistor may further include a second electrode configured to receive a fourth voltage, wherein the second voltage includes a low power voltage, and wherein the fourth voltage includes another low power voltage that is different from the second voltage.

The fourth voltage may be less than the second voltage.

The eighth transistor may further include a second electrode connected to the third node.

The driver may further include an eighth transistor including a control electrode connected to the third node, and a first electrode connected to the first node, wherein the fourth transistor further includes a second electrode configured to receive a third voltage including a low power voltage that is different from the second voltage.

The eighth transistor may further include a second electrode configured to receive a fourth voltage including another low power voltage that is different from the second voltage.

The third voltage may be greater than the second voltage, wherein the fourth voltage is less than the second voltage.

The eighth transistor may further include a second electrode connected to the third node.

The first transistor may further include a second control electrode connected to the control electrode of the first transistor, wherein the second transistor further includes a second control electrode connected to the control electrode of the second transistor, wherein the third transistor further includes a second control electrode connected to the control electrode of the third transistor, wherein the fifth transistor further includes a second control electrode connected to the control electrode of the fifth transistor, and wherein the sixth transistor further include a second control electrode connected to the control electrode of the sixth transistor.

The driver may further include a seventh transistor including a control electrode configured to receive a reset signal, a first electrode connected to the second node, and a second electrode connected to a second electrode of the fourth transistor.

The driver may further include a seventh transistor including a control electrode configured to receive a reset signal, a first electrode configured to receive the first voltage, and a second electrode connected to the first node.

In one or more embodiments of a display apparatus, the display apparatus includes a display panel including a pixel, a gate driver configured to output a gate signal to the pixel, a data driver configured to output a data voltage to the pixel, and an emission driver configured to output an emission signal to the pixel, wherein the gate driver or the emission driver includes at least one stage including a first transistor including a control electrode configured to receive a clock signal, a first electrode configured to receive an input signal, and a second electrode connected to a first node, a second transistor including a control electrode connected to the first node, a first electrode configured to receive a first voltage, and a second electrode connected to a second node, a third transistor including a control electrode configured to receive a second voltage, a first electrode connected to the first node, and a second electrode connected to a third node, a fourth transistor including an NMOS transistor including a control electrode connected to the first node, and a first electrode connected to the second node, and configured to have a gate-source voltage that is less than zero, a fifth transistor including a control electrode connected to the second node, a first electrode configured to receive the first voltage, and a second electrode connected to an output node, and a sixth transistor including a control electrode connected to the third node, a first electrode connected to the output node, and a second electrode configured to receive the second voltage.

In one or more embodiments of an electronic apparatus, the electronic apparatus includes a display panel including a pixel, a gate driver configured to output a gate signal to the pixel, a data driver configured to output a data voltage to the pixel, an emission driver configured to output an emission signal to the pixel, a driving controller configured to control the gate driver, the data driver, and the emission driver, and a processor configured to output image data and a control signal to the driving controller, wherein the gate driver or the emission driver includes at least one stage including a first transistor including a control electrode configured to receive a clock signal, a first electrode configured to receive an input signal, and a second electrode connected to a first node, a second transistor including a control electrode connected to the first node, a first electrode configured to receive a first voltage, and a second electrode connected to a second node, a third transistor including a control electrode configured to receive a second voltage, a first electrode connected to the first node, and a second electrode connected to a third node, a fourth transistor including an NMOS transistor including a control electrode connected to the first node, and a first electrode connected to the second node, and configured to have a gate-source voltage that is less than zero, a fifth transistor including a control electrode connected to the second node, a first electrode configured to receive the first voltage, and a second electrode connected to an output node, and a sixth transistor including a control electrode connected to the third node, a first electrode connected to the output node, and a second electrode configured to receive the second voltage.

According to the driver, the display apparatus including the driver and the electronic apparatus including the driver, a voltage that is greater than a low power voltage may be applied to the second electrode of the fourth transistor, which may be the NMOS transistor in the CMOS-type driver, or a voltage that is less than the low power voltage may be applied to the control electrode of the fourth transistor, to operate the gate-source voltage of the fourth transistor in a negative region.

In addition, the second control electrode of the fourth transistor may be connected to the control electrode of the fourth transistor.

The voltage that is greater than the low power voltage may be applied to the second electrode of the fourth transistor, which may be the NMOS transistor in the CMOS-type driver, or the voltage that is less than the low power voltage may be applied to the control electrode of the fourth transistor, so that the current leakage of the fourth transistor may be reduced. The current leakage of the fourth transistor is reduced so that the reliability of the CMOS-type driver may be enhanced.

### BRIEF DESCRIPTION OF THE DRAWINGS

The above and other aspects of the present disclosure will become more apparent by describing in detailed embodiments thereof with reference to the accompanying drawings, in which:

FIG. 1 is a block diagram illustrating a display apparatus according to embodiments of the present disclosure.

FIG. 2A is a block diagram illustrating a gate driver of FIG. 1.

FIG. 2B is a block diagram illustrating an emission driver of FIG. 1.

FIG. 3 is a timing diagram illustrating an example of an operation of the driver of FIG. 2A and FIG. 2B.

FIG. 4 is a circuit diagram illustrating a stage of the driver of FIG. 2A and FIG. 2B.

FIG. 5 is a timing diagram illustrating an example of an operation of the stage of FIG. 4.

FIG. 6 is a circuit diagram illustrating an example of a pixel of a display panel of FIG. 1.

FIG. 7 is a timing diagram illustrating an example of input signals of the pixel of FIG. 6.

FIG. 8 is a timing diagram illustrating an example of input signals of the pixel of FIG. 6.

FIG. 9 is a circuit diagram illustrating an example of a pixel of a display panel of FIG. 1.

FIG. 10 is a timing diagram illustrating an example of input signals of the pixel of FIG. 9.

FIG. 11 is a timing diagram illustrating an example of input signals of the pixel of FIG. 9.

FIG. 12 is a circuit diagram illustrating a stage of a driver of a display apparatus according to embodiments of the present disclosure.

FIG. 13 is a circuit diagram illustrating a stage of a driver of a display apparatus according to embodiments of the present disclosure.

FIG. 14 is a circuit diagram illustrating a stage of a driver of a display apparatus according to embodiments of the present disclosure.

FIG. 15 is a circuit diagram illustrating a stage of a driver of a display apparatus according to embodiments of the present disclosure.

FIG. 16 is a circuit diagram illustrating a stage of a driver of a display apparatus according to embodiments of the present disclosure.

FIG. 17 is a circuit diagram illustrating a stage of a driver of a display apparatus according to embodiments of the present disclosure.

FIG. 18 is a circuit diagram illustrating a stage of a driver of a display apparatus according to embodiments of the present disclosure.

FIG. 19 is a block diagram illustrating an electronic apparatus according to embodiments of the present disclosure.

FIG. 20 is a diagram illustrating an example of the electronic apparatus of FIG. 19 implemented as a smart phone.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing embodiments corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

It will be understood that when an element, layer, region, or component (e.g., an apparatus, a device, a circuit, a wire, an electrode, a terminal, a conductive film, and/or the like) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” and/or the like, may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” and/or the like. may also be used herein to differentiate different categories or sets of elements. For conciseness, the terms “first,” “second,” and/or the like may represent “first-category (or first-set),” “second-category (or second-set),” and/or the like, respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware, to process data or digital signals. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Circuit hardware may include, for example, application specific integrated circuits (ASICs), general purpose or special purpose central processing units (CPUs) that is configured to execute instructions stored in a non-transitory storage medium, digital signal processors (DSPs), graphics processing units (GPUs), and programmable logic devices, such as field programmable gate arrays (FPGAs).

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, the present disclosure will be explained in detail with reference to the accompanying drawings.

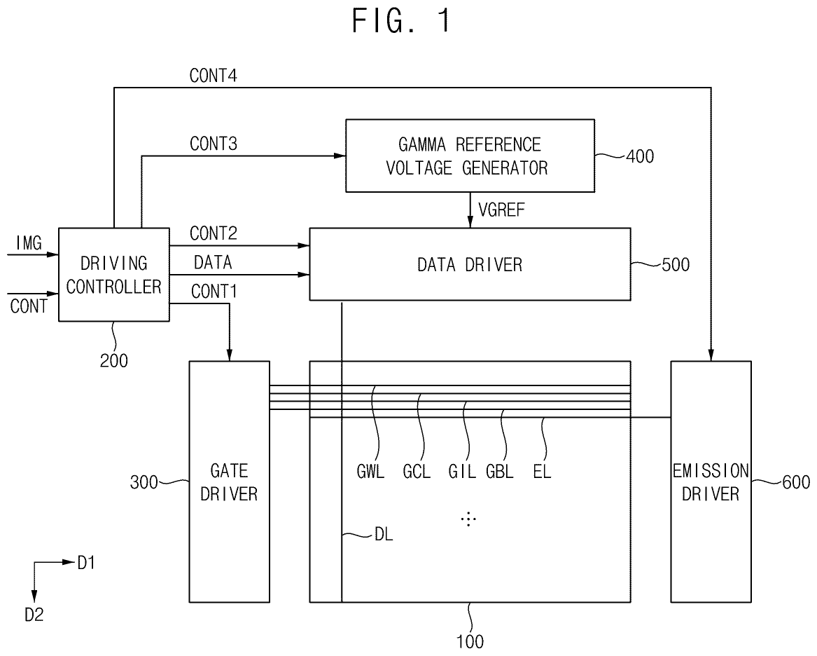

FIG. 1 is a block diagram illustrating a display apparatus according to embodiments of the present disclosure.

Referring to FIG. 1, the display apparatus may include a display panel 100 and/or a display panel driver. The display panel driver may include a driving controller 200, a gate driver 300, a gamma reference voltage generator 400, a data driver 500 and/or an emission driver 600.

The display panel 100 may include a display region on which an image is displayed and/or a peripheral region that may be adjacent (e.g., near, adjoining, and/or the like) to the display region.

The display panel 100 may include a plurality of gate lines GWL, GCL, GIL, and GBL, a plurality of data lines DL, a plurality of emission lines EL and/or a plurality of pixels that may be electrically connected to the gate lines GWL, GCL, GIL, and GBL, the data lines DL and/or the emission lines EL. The gate lines GWL, GCL, GIL, and GBL may extend in a direction D1 (e.g., a horizontal direction), the data lines DL may extend in another direction D2 (e.g., a vertical direction) that may cross (e.g., may be substantially perpendicular to) the direction D1, and the emission lines EL may extend in the direction D1.

The driving controller 200 may receive an input image data IMG and an input control signal CONT from an external apparatus (e.g., an apparatus that is outside of the display apparatus). For example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4 and/or a data signal DATA based on the input image data IMG and/or the input control signal CONT.

The driving controller 200 may generate the first control signal CONT1 for controlling an operation of the gate driver 300 based on the input control signal CONT, and may output the first control signal CONT1 to the gate driver 300. The first control signal CONT1 may include a vertical start signal and/or a gate clock signal.

The driving controller 200 may generate the second control signal CONT2 for controlling an operation of the data driver 500 based on the input control signal CONT, and may output the second control signal CONT2 to the data driver 500. The second control signal CONT2 may include a horizontal start signal and/or a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and may output the third control signal CONT3 to the gamma reference voltage generator 400.

The driving controller 200 may generate the fourth control signal CONT4 for controlling an operation of the emission driver 600 based on the input control signal CONT, and may output the fourth control signal CONT4 to the emission driver 600.

The gate driver 300 may generate gate signals that may drive (e.g., that may be formed on, provided by, carried by, and/or the like) the gate lines GWL, GCL, GIL, and GBL based on the first control signal CONT1 received from the driving controller 200 (as used herein, “based on” may mean “in response to,” or “corresponding to,” as appropriate). The gate driver 300 may output the gate signals to the gate lines GWL, GCL, GIL, and GBL.

The gamma reference voltage generator 400 may generate a gamma reference voltage VGREF based on the third control signal CONT3 received from the driving controller 200. The gamma reference voltage generator 400 may provide the gamma reference voltage VGREF to the data driver 500. The gamma reference voltage VGREF may have a value that may correspond to a level of the data signal DATA.

In one or more embodiments, the gamma reference voltage generator 400 may be arranged in the driving controller 200, and/or in the data driver 500.

The data driver 500 may receive the second control signal CONT2 and/or the data signal DATA from the driving controller 200, and/or may receive the gamma reference voltage VGREF from the gamma reference voltage generator 400. The data driver 500 may convert the data signal DATA into data voltages having an analog type using the gamma reference voltage VGREF. The data driver 500 may output the data voltages to the data lines DL.

The emission driver 600 may generate emission signals to drive the emission lines EL based on the fourth control signal CONT4 received from the driving controller 200. The emission driver 600 may output the emission signals to the emission lines EL.

The gate driver 300 may be arranged at a first side of the display panel 100 and/or the emission driver 600 may be at a second side of the display panel 100 that may be separate from (e.g., opposite to) the first side in FIG. 1 for example, but one or more embodiments of the present disclosure may not be limited thereto. For example, the gate driver 300 and/or the emission driver 600 may be arranged at the first side of the display panel 100. For example, the gate driver 300 and/or the emission driver 600 may be arranged at both sides (e.g., opposite sides) of the display panel 100. For example, the gate driver 300 and/or the emission driver 600 may be integrally formed (or provided).

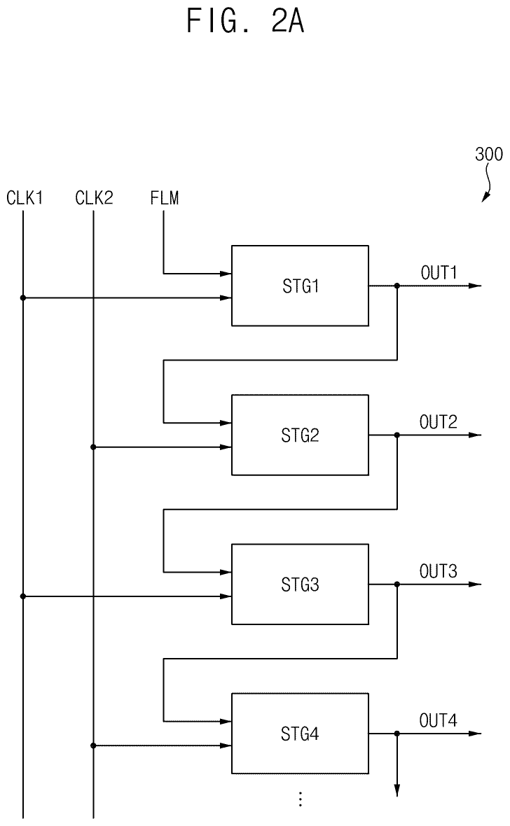

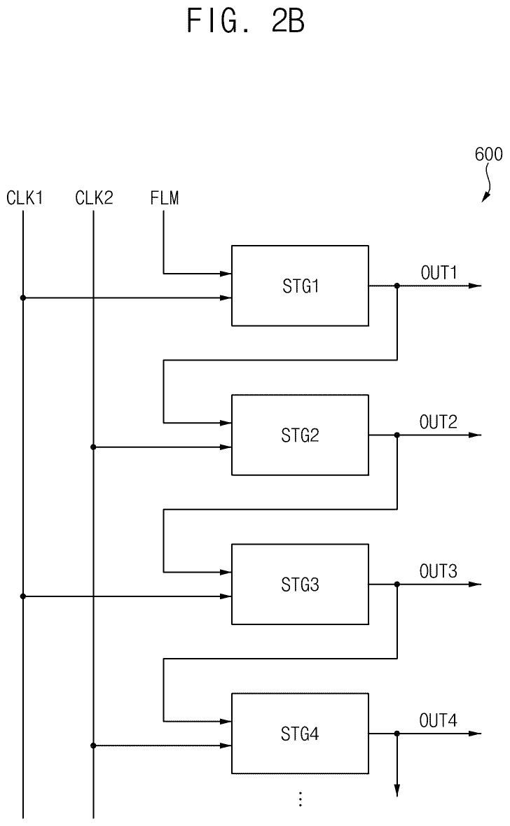

FIG. 2A is a block diagram illustrating a gate driver 300 of FIG. 1. FIG. 2B is a block diagram illustrating an emission driver 600 of FIG. 1. FIG. 3 is a timing diagram illustrating an example of an operation of the drivers of FIG. 2A and/or FIG. 2B.

For example, the driver may be the gate driver 300 outputting the gate signal in FIG. 2A. For example, the driver may be the emission driver 600 outputting the emission signal in FIG. 2B. As such, a driver circuit, according to one or more embodiments of the present disclosure, may be applied to the gate driver 300 and/or the emission driver 600.

Referring to FIGS. 2A and 2B, the driver, according to one or more embodiments of the present disclosure, may include a plurality of stages STG1, STG2, STG3, STG4, and so on. The driver may be implemented as a shift register in which the stages STG1, STG2, STG3, STG4, and so on, may provide (e.g., sequentially output) the output signals OUT1, OUT2, OUT3, OUT4, and so on. In one or more embodiments, the driver may be included in the display apparatus and may be formed (or provided) on the display panel 100. For example, the driver may be integrated and/or arranged on a substrate of the display panel 100.

The stages STG1, STG2, STG3, STG4 (and so on) may output (e.g., sequentially output) the output signals OUT1, OUT2, OUT3, OUT4 (and so on) based on a start signal FLM, a first clock signal CLK1 and/or a second clock signal CLK2. A first stage STG1 may receive the start signal FLM as an input signal and one or more of (e.g., each of) the subsequent stages STG2, STG3, STG4 (and so on) may receive the output signal from the previous stage as the input signal. For example, a second stage STG2 may receive a first output signal OUT1 of the first stage STG1 as the input signal, a third stage STG3 may receive a second output signal OUT2 of the second stage STG2 as the input signal and a fourth stage STG4 may receive a third output signal OUT3 of the third stage STG3 as the input signal

In one or more embodiments, the odd-numbered stages STG1, STG3 (and so on) may start to output the output signals OUT1, OUT3 (and so on) if (as used herein, “if” may mean “when,” as appropriate) the first clock signal CLK1 has a relatively low level, and the even-numbered stages STG2, STG4 (and so on) may start to output the output signals OUT2, OUT4 (and so on) if the second clock signal CLK2 has a relatively low level.

For example, as illustrated in FIG. 2A to FIG. 3, if the first clock signal CLK1 goes to (as used herein, “goes to” may mean “becomes,” as appropriate) the relatively low level after the start signal FLM goes to a relatively high level, the first stage STG1 may start to output the first output signal OUT1 having a relatively high level. In one or more embodiments, if the first clock signal CLK1 goes to the relatively low level after the start signal FLM goes to a relatively low level, the first stage STG1 may start to output the first output signal OUT1 having a relatively low level.

In one or more embodiments, the second clock signal CLK2 may go to the relatively low level after the first output signal OUT1 goes to the relatively high level, and the second stage STG2 may start to output the second output signal OUT2 having a relatively high level. In one or more embodiments, if the second clock signal CLK2 goes to the relatively low level after the first output signal OUT1 goes to a relatively low level, the second stage STG2 may start to output the second output signal OUT2 having a relatively low level.

If the first clock signal CLK1 goes to the relatively low level after the second output signal OUT2 goes to the relatively high level, the third stage STG3 may start to output the third output signal OUT3 having a relatively high level. In one or more embodiments, if the first clock signal CLK1 goes to the relatively low level after the second output signal OUT2 goes to a relatively low level, the third stage STG3 may start to output the third output signal OUT3 having a relatively low level.

In this way, the stages STG1, STG2, STG3, STG4, and so on, may output (e.g., sequentially output) the output signals OUT1, OUT2, OUT3, OUT4, and so on, such that the output signals OUT1, OUT2, OUT3, OUT4, and so on, may be delayed and/or shifted by half of a cycle of the first clock signal CLK1.

In one or more embodiments, one of the first clock signal CLK1 or the second clock signal CLK2 may be applied to one or more of the stages (e.g., each stage). For example, the first clock signal CLK1 may be applied to the odd-numbered stages STG1, STG3, and so on. For example, the second clock signal CLK2 may be applied to the even-numbered stages STG2, STG4, and so on.

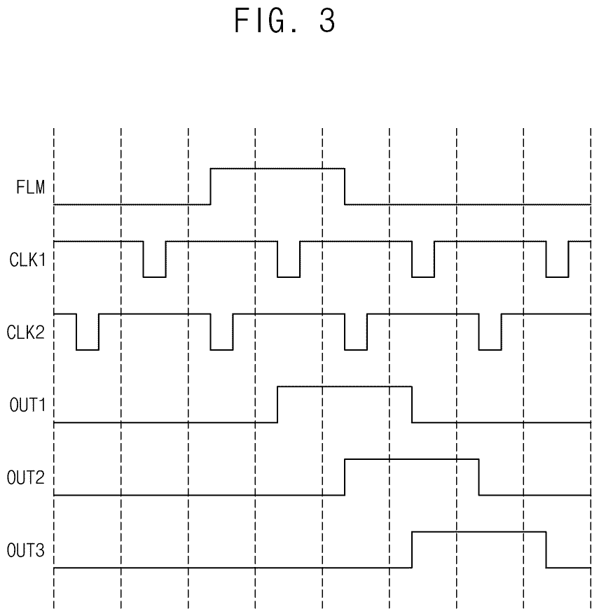

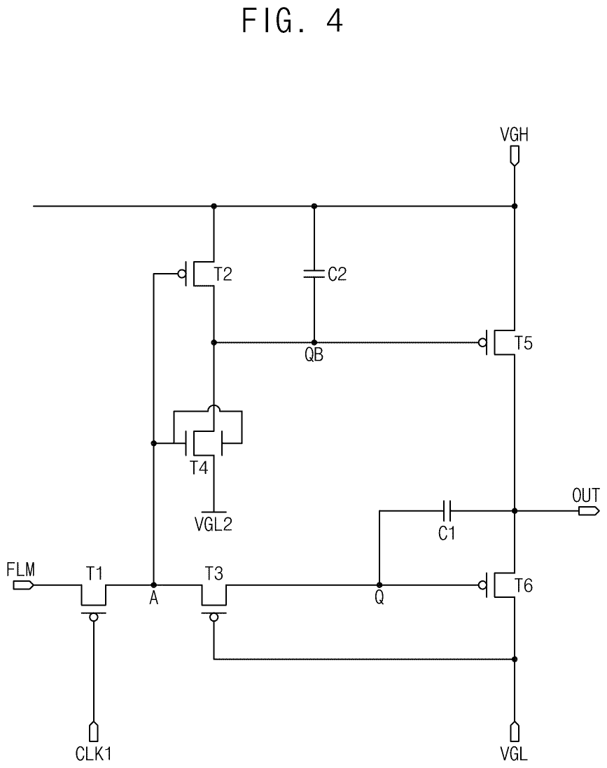

FIG. 4 is a circuit diagram illustrating a stage of the driver of FIG. 2A and/or FIG. 2B. FIG. 5 is a timing diagram illustrating an example of an operation of the stage of FIG. 4.

Referring to FIG. 1 to FIG. 5, the stage of the driver may include a CMOS-type driver including one or more P-type Metal-Oxide Semiconductor (PMOS) transistors and/or one or more NMOS transistors. Each of the one or more transistors may include at least a corresponding control electrode, a corresponding first electrode, and a corresponding second electrode, in one or more embodiments.

The stage of the driver may include a first transistor T1, a second transistor T2, a third transistor T3, a fourth transistor T4, a fifth transistor T5 and/or a sixth transistor T6. The first transistor T1 may include a control electrode for receiving the first clock signal CLK1, a first electrode for receiving an input signal (the start signal FLM and/or an output signal of a previous stage), and a second electrode connected to a first node A. The second transistor T2 may include a control electrode connected to the first node A, a first electrode for receiving a relatively high power voltage VGH (e.g., referred to as “first voltage” in the claims) and a second electrode connected to a second node QB. The third transistor T3 may include a control electrode for receiving a relatively low power voltage VGL (e.g., referred to as “second voltage” in the claims), a first electrode connected to the first node A and a second electrode connected to a third node Q. The fourth transistor T4 may include a control electrode connected to the first node A and a first electrode connected to the second node QB. The fifth transistor T5 may include a control electrode connected to the second node QB, a first electrode for receiving the relatively high power voltage VGH and a second electrode connected to an output node. The sixth transistor T6 may include a control electrode connected to the third node A, a first electrode connected to the output node and a second electrode for receiving the relatively low power voltage VGL. The fourth transistor T4 may be an NMOS transistor. A gate-source voltage of the fourth transistor T4 may be a determined value, for example less than zero volts.

The first transistor T1 may output the input signal to the first node A based on the first clock signal CLK1. The first transistor T1 may function as a delay circuit. Thus, the input signal may be delayed by one horizontal cycle and transmitted to the first node A by the first transistor T1.

The second transistor T2 and/or the fourth transistor T4 may invert a signal of the first node A and output the inverted signal of the first node A to the second node QB. The second transistor T2 and/or the fourth transistor T4 may operate substantially like an inverter (as used herein, “operate substantially like” may mean “function as,” as appropriate). A signal of the second node QB may have a waveform which is inverted from a waveform of the signal of the first node A.

The third transistor T3 may transmit the signal of the first node A to the third node Q. The driver may further include a first capacitor C1 including a first electrode connected to the third node Q and a second electrode connected to the output node. A signal of the third node Q may be bootstrapped by the first capacitor C1. The signal of the third node Q may have a relatively high level H and/or a second relatively low level 2L. For example, the second low level 2L may be greater than (e.g., may be equal to twice that of) the relatively low power voltage VGL.

The fifth transistor T5 may pull up the output signal OUT to the relatively high power voltage VGH based on the signal of the second node QB. The fifth transistor T5 may operate substantially like a pull-up circuit.

The sixth transistor T6 may pull down the output signal OUT to the relatively low power voltage VGL based on the signal of the third node Q. The sixth transistor T6 may function as a pull-down circuit.

A control signal of the fifth transistor T5 which may operate substantially like the pull-up circuit may be the signal of the second node QB, and a control signal of the sixth transistor T6 which may operate substantially like the pull-down circuit may be the signal of the third node Q. The output signal OUT may have a waveform that is substantially the same as a waveform of the signal of the first node A and/or a waveform of the signal of the third node Q by the fifth transistor T5 and/or the sixth transistor T6. A relatively low level L of the output signal OUT may be the relatively low power voltage VGL and a relatively low level 2L of the signal of the third node Q may be less than the low power voltage VGL (as used herein, “less than” may mean “lower than,” as appropriate).

In one or more embodiments, the relatively low level (e.g., 2*VGL) of the third node Q may go to less than the relatively low power voltage VGL in a pull-down operation so that the sixth transistor T6 may be suitably (e.g., sufficiently) turned on so that a reliability of the operation of the driver may be enhanced or increased.

In one or more embodiments, the sixth transistor T6 which may operate substantially like the pull-down circuit, may be implemented as a PMOS transistor (e.g., in lieu of an NMOS transistor) so that a negative shift of a threshold voltage that may occur (e.g., when the pull-down circuit is implemented as the NMOS transistor) may be prevented or reduced. Further, utilizing the PMOS transistor may prevent or reduce an increase of a size of the NMOS transistor (of the pull-down circuit) to compensate for mobility of the NMOS transistor, and may also prevent or reduce an increase of a dead (e.g., inactive) space of the display panel 100.

The driver may further include a second capacitor C2 including a first electrode for receiving the relatively high power voltage VGH and a second electrode connected to the second node QB.

For example, the first transistor T1, the second transistor T2, the third transistor T3, the fifth transistor T5 and/or the sixth transistor T6 may be PMOS transistors.

In one or more embodiments, an active area of the PMOS transistor (e.g., T1, T2, T3, T5, and/or T6) may include a polycrystalline silicon. In one or more embodiments, an active area of the NMOS transistor (e.g., the fourth transistor T4) may include an oxide semiconductor.

The fourth transistor T4 may further include a second control electrode connected to the control electrode of the fourth transistor T4. The fourth transistor T4 may further includes the second control electrode which may be gate-synced so that a reliability of the fourth transistor T4 may be enhanced or increased.

In one or more embodiments, the fourth transistor T4 may further include a second electrode for receiving a second relatively low power voltage VGL2 (e.g., referred to as a “third voltage” in the claims) that may be different from the relatively low power voltage VGL. Herein, the second relatively low power voltage VGL2 may be greater than the low power voltage VGL.

In one or more embodiments, the second relatively low power voltage VGL2 may be applied to the second electrode of the fourth transistor T4 such that a gate-source voltage of the fourth transistor T4 may be a determined value, for example less than zero volts (as used herein, “determined value” may mean “set value,” as appropriate).

If a relatively low level of the start signal FLM is less than the relatively low power voltage VGL, a relatively low level of the first node A may go to a determined value (e.g., VGL+|VTH_T1|) and the gate-source voltage VGS_T4 of the fourth transistor T4 may go to a determined value (e.g., VGL+|VTH_T1|-VGL2). Herein, “|VTH_T1|” may refer to a threshold voltage of the first transistor T1.

In one or more embodiments, the second low power voltage VGL2 may be substantially the same as (e.g., equal to) the relatively low power voltage VGL. If the first node A has a relatively low level, the gate-source voltage VGS_T4 of the fourth transistor T4 may go to |VTH_T1| and the fourth transistor T4 may be turned on. If the first node A has a relatively low level, the second transistor T2 and/or the fourth transistor T4 may be turned on so that a current may be leaked through the second transistor T2 and/or the fourth transistor T4. Accordingly, an output defect of the driver may occur.

If the second low power voltage VGL2 is set to a value (e.g., VGL+|VTH_T1|) and the first node A has the relatively low level, the gate-source voltage VGS_T4 of the fourth transistor T4 may go to zero so that the fourth transistor T4 may be turned off.

If the second low power voltage VGL2 is set to be lower than the determined value (e.g., VGL+|VTH_T1|) and the first node A has the relatively low level, the gate-source voltage VGS_T4 of the fourth transistor T4 may go to a negative value so that the fourth transistor T4 may be suitably (e.g., sufficiently) turned off.

Thus, if the second relatively low power voltage VGL2 is set to be lower than (e.g., reduced from) the relatively low power voltage VGL, the reliability of the operation of the driver may be enhanced and/or increased.

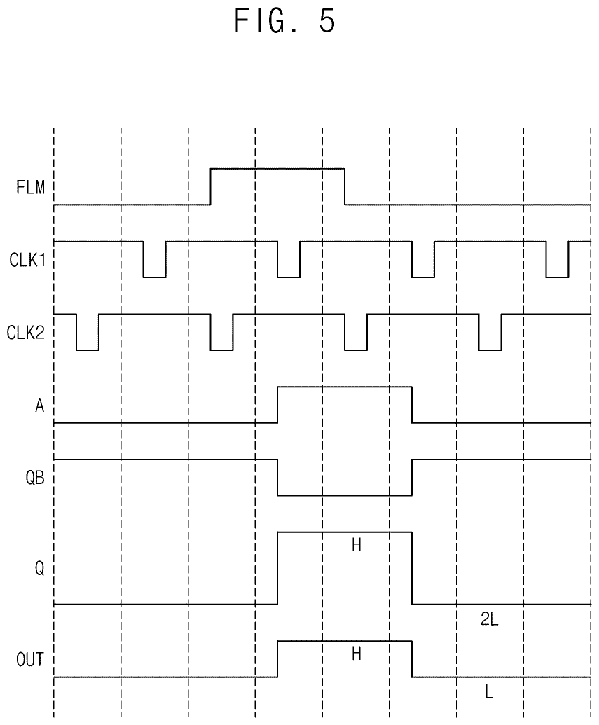

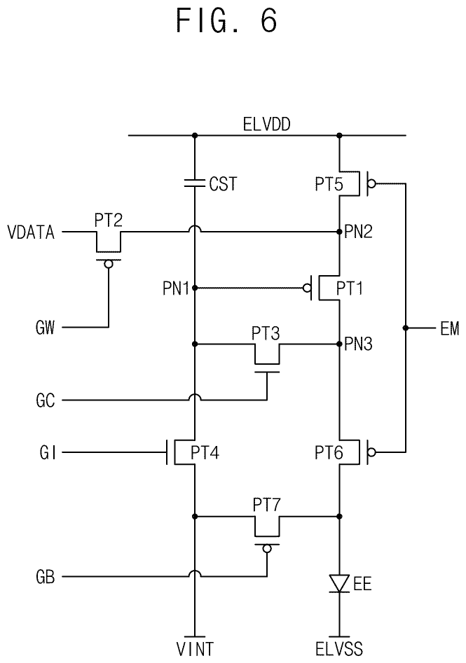

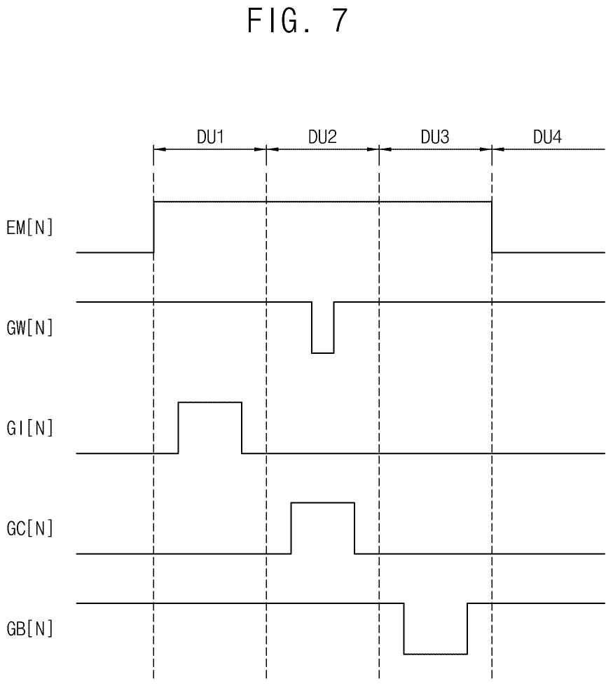

FIG. 6 is a circuit diagram illustrating an example of a pixel of a display panel 100 of FIG. 1. FIG. 7 is a timing diagram illustrating an example of input signals of the pixel of FIG. 6. FIG. 8 is a timing diagram illustrating an example of input signals of the pixel of FIG. 6.

Referring to FIG. 1 to FIG. 8, the display panel 100 may include the plurality of pixels. One or more of the pixels (e.g., each pixel) may include a light-emitting element EE.

The pixel may receive a writing gate signal GW, a compensation gate signal GC, a data initialization gate signal GI, a light-emitting element initialization gate signal GB, the data voltage VDATA and/or the emission signal EM, and the light-emitting element EE of the pixel may emit light based on the level of the data voltage VDATA to display the image.

In one or more embodiments, the pixel may include a switching element of a first type and/or a switching element of a second type that may be different from the first type (as used herein, “type” may mean “kind”). For example, the switching element of the first type may be a P-type transistor and the switching element of the second type may be an N-type transistor.

For example, the switching element of the first type may be a polycrystalline silicon thin film transistor. For example, the switching element of the first type may be a low temperature polycrystalline silicon (LTPS) thin film transistor. For example, the switching element of the second type may be an oxide semiconductor thin film transistor.

In one or more embodiments, at least one of the pixels may include the first to seventh pixel switching elements PT1 to PT7, a storage capacitor CST and/or the light-emitting element EE.

The first pixel switching element PT1 may include a control electrode connected to a first pixel node PN1, a first electrode connected to a second pixel node PN2, and a second electrode connected to a third pixel node PN3.

The second pixel switching element PT2 may include a control electrode for receiving the writing gate signal GW, a first electrode for receiving the data voltage VDATA and a second electrode connected to the second pixel node PN2.

The third pixel switching element PT3 may include a control electrode for receiving the compensation gate signal GC, a first electrode connected to the first pixel node PN1 and a second electrode connected to the third pixel node PN3.

The fourth pixel switching element PT4 may include a control electrode for receiving the data initialization gate signal GI, a first electrode for receiving an initialization voltage VINT and a second electrode connected to the first pixel node PN1.

The fifth pixel switching element PT5 may include a control electrode for receiving the emission signal EM, a first electrode for receiving a pixel high power voltage ELVDD and a second electrode connected to the second pixel node PN2.

The sixth pixel switching element PT6 may include a control electrode for receiving the emission signal EM, a first electrode connected to the third pixel node PN3 and a second electrode connected to an anode electrode of the light-emitting element EE.

The seventh pixel switching element PT7 may include a control electrode for receiving the light-emitting element initialization gate signal GB, a first electrode for receiving the initialization voltage VINT and a second electrode connected to the anode electrode of the light-emitting element EE.

The storage capacitor CST may include a first electrode for receiving the pixel high power voltage ELVDD and a second electrode connected to the first pixel node PN1.

The light-emitting element EE may include the anode electrode and a cathode electrode for receiving a pixel low power voltage ELVSS.

In one or more embodiments, the third pixel switching element PT3 and/or the fourth pixel switching element PT4 may be N-type transistors. The first pixel switching element PT1, the second pixel switching element PT2, the fifth pixel switching element PT5, the sixth pixel switching element PT6 and/or the seventh pixel switching element PT7 may be P-type transistors.

In FIG. 7, for example during a first duration DU1, the first pixel node PN1 and the storage capacitor CST may be initialized based on the data initialization gate signal Gl. During a second duration DU2, a threshold voltage |VTH| of the first pixel switching element PT1 may be compensated and the data voltage VDATA, of which the threshold voltage |VTH| may be compensated, may be written to the first pixel node PN1 based on the writing gate signals GW and the compensation gate signal GC. During a third duration DU3, the anode electrode of the light-emitting element EE may be initialized based on the light-emitting element initialization gate signal GB. During a fourth duration DU4, the light-emitting element EE may emit the light based on the emission signal EM so that the display panel 100 may display the image.

In one or more embodiments, an emission off duration of the emission signal EM may be based on the first through third durations DU1, DU2 and/or DU3, however embodiments of the present disclosure are not limited thereto. The emission off duration of the emission signal EM may be set to include the data writing duration DU2, in one or more embodiments. The emission off duration of the emission signal EM may be longer than a determined duration (e.g., sum of the first to third durations DU1, DU2, and DU3), in one or more embodiments.

During the first duration DU1, the data initialization gate signal GI may have an active level. For example, the active level of the data initialization gate signal GI may be a relatively high level. If the data initialization gate signal GI has the active level, the fourth pixel switching element PT4 may be turned on so that the initialization voltage VINT may be applied to the first pixel node PN1.

During the second duration DU2, the writing gate signal GW and/or the compensation gate signal GC may have an active level. For example, the active level of the writing gate signal GW may be a relatively low level and the active level of the compensation gate signal GC may be a relatively high level. If the writing gate signal GW and/or the compensation gate signal GC have the active level, the second pixel switching element PT2 and/or the third pixel switching element PT3 may be turned on. In one or more embodiments, the first pixel switching element PT1 may be turned on based on the initialization voltage VINT.

A voltage which may be a subtraction of an absolute value |VTH| of the threshold voltage of the first pixel switching element PT1 from the data voltage VDATA, and may be charged at the first pixel node PN1 along a path provided (e.g., generated) by the first to third pixel switching elements PT1, PT2 and/or PT3.

During the third duration DU3, the light-emitting element initialization gate signal GB may have an active level. For example, the active level of the light-emitting element initialization gate signal GB may be a relatively low level. If the light-emitting element initialization gate signal GB has the active level, the seventh pixel switching element PT7 may be turned on so that the initialization voltage VINT may be applied to the anode electrode of the light-emitting element EE.

In one or more embodiments, the initialization voltage applied to the fourth pixel switching element PT4 may be substantially the same as the initialization voltage applied to the seventh pixel switching element PT7, however embodiments of the present disclosure are not limited thereto. In one or more embodiments, the initialization voltage applied to the fourth pixel switching element PT4 may be different from the initialization voltage applied to the seventh pixel switching element PT7.

During the fourth duration DU4, the emission signal EM may have an active level. For example, the active level of the emission signal EM may be a relatively low level. If the emission signal EM has the active level, the fifth pixel switching element PT5 and/or the sixth pixel switching element PT6 may be turned on. In one or more embodiments, the first pixel switching element PT1 may be turned on by the data voltage VDATA.

A driving current may flow through the fifth pixel switching element PT5, the first pixel switching element PT1 and/or the sixth pixel switching element PT6 to drive (or control) the light-emitting element EE. An intensity of the driving current may be determined by the level of the data voltage VDATA. A luminance of the light-emitting element EE may be determined by the intensity of the driving current.

In FIG. 7, “[N]” may indicate a signal of a present stage. A signal of a previous stage or a signal of a next stage may not be applied to the pixel circuit in FIGS. 6 and 7, in one or more embodiments, so “[N]” may not be provided (e.g., may be omitted) in FIG. 7.

In one or more embodiments, the output signal OUT of the stage circuit of FIG. 4 may be the compensation gate signal GC applied to the third pixel switching element PT3.

A timing diagram of FIG. 8 may be substantially the same as the timing diagram of FIG. 7. In one or more embodiments, the data initialization gate signal GI and/or the compensation gate signal GC may be provided by (e.g., generated from) the driver (e.g., same driver). Thus, for brevity, substantially similar elements and/or functions are not described in detail again in reference to FIG. 8.

In FIG. 8, “[N]” may indicate a signal of a present stage and [N-M] may indicate a signal of an M-th previous stage. The “[N]” for the signal of the present stage may not be provided (e.g., may be omitted).

In one or more embodiments, the output signal OUT of the stage circuit of FIG. 4 may be the compensation gate signal GC[N] applied to the third pixel switching element PT3 and/or the data initialization gate signal GC[N-M] applied to the fourth pixel switching element PT4.

As shown in FIG. 8, the data initialization gate signal GC[N-M] may have a timing before (e.g., earlier than) a timing of the compensation gate signal GC[N] in a frame.

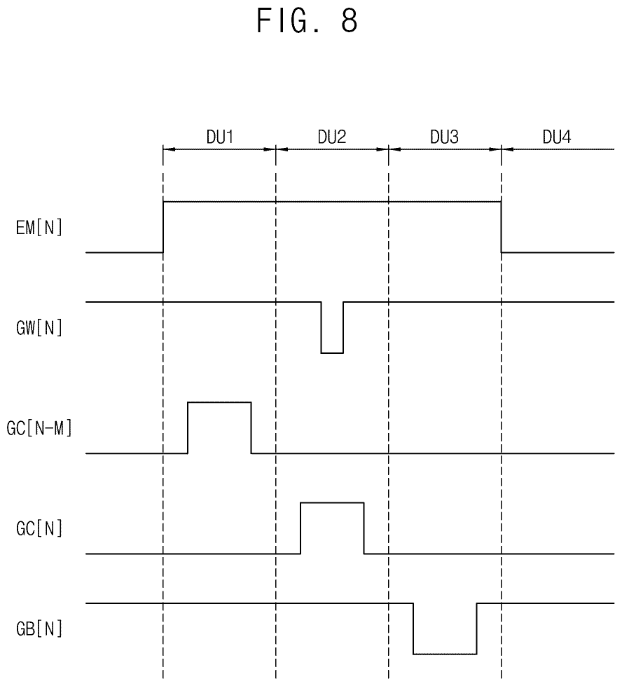

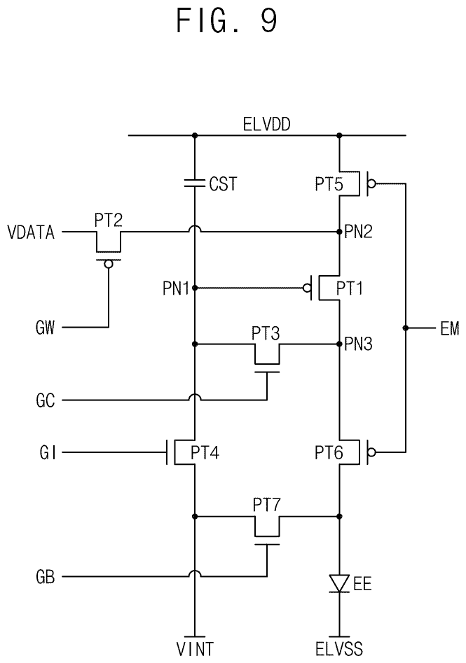

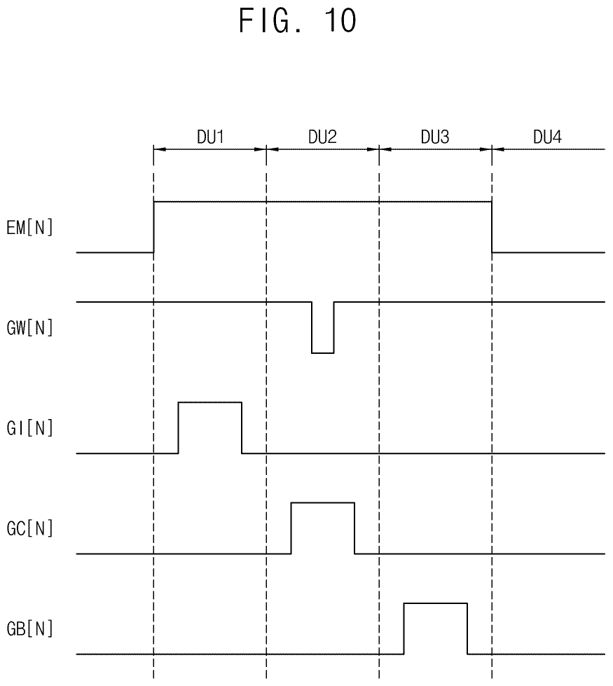

FIG. 9 is a circuit diagram illustrating an example of a pixel of a display panel 100 of FIG. 1. FIG. 10 is a timing diagram illustrating an example of input signals of the pixel of FIG. 9. FIG. 11 is a timing diagram illustrating an example of input signals of the pixel of FIG. 9.

A pixel circuit of FIG. 9 may be substantially the same as the pixel circuit of FIG. 6. In or more embodiments, the seventh pixel switching element PT7 may be an N-type transistor. Thus, for brevity, substantially similar elements and/or functions are not described in detail again in reference to FIG. 9.

Referring to FIG. 1 to FIG. 5 and FIG. 9 to FIG. 11, the display panel 100 may include the plurality of pixels. One or more of the pixels (e.g., each pixel) may include a light-emitting element EE.

The pixel may receive a writing gate signal GW, a compensation gate signal GC, a data initialization gate signal GI, a light-emitting element initialization gate signal GB, the data voltage VDATA and/or the emission signal EM, and the light-emitting element EE of the pixel may be to emit light based on the level of the data voltage VDATA to display the image.

In one or more embodiments, the pixel may include a switching element of a first type and/or a switching element of a second type that may be different from the first type. For example, the switching element of the first type may be a P-type transistor and the switching element of the second type may be an N-type transistor.

For example, the switching element of the first type may be a polycrystalline silicon thin film transistor. For example, the switching element of the first type may be a low temperature polycrystalline silicon (LTPS) thin film transistor. For example, the switching element of the second type may be an oxide semiconductor thin film transistor.

At least one of the pixels may include the first to seventh pixel switching elements PT1 to PT7, a storage capacitor CST and the light-emitting element EE.

In one more embodiments, the third pixel switching element PT3, the fourth pixel switching element PT4 and/or the seventh pixel switching element PT7 may be N-type transistors. The first pixel switching element PT1, the second pixel switching element PT2, the fifth pixel switching element PT5 and/or the sixth pixel switching element PT6 may be P-type transistors.

In FIG. 10, for example during a first duration DU1, the first pixel node PN1 and/or the storage capacitor CST are initialized based on the data initialization gate signal Gl. During a second duration DU2, a threshold voltage |VTH| of the first pixel switching element PT1 may be compensated and the data voltage VDATA, of which the threshold voltage |VTH| may be compensated, may be written to the first pixel node PN1 based on the writing gate signals GW and/or the compensation gate signal GC. During a third duration DU3, the anode electrode of the light-emitting element EE may be initialized based on the light-emitting element initialization gate signal GB. During a fourth duration DU4, the light-emitting element EE may emit the light based on the emission signal EM so that the display panel 100 displays the image.

During the third duration DU3, the light-emitting element initialization gate signal GB may have an active level. For example, the active level of the light-emitting element initialization gate signal GB may be a relatively high level. If the light-emitting element initialization gate signal GB has the active level, the seventh pixel switching element PT7 may be turned on so that the initialization voltage VINT may be applied to the anode electrode of the light-emitting element EE.

In FIG. 10, “[N]” may indicate a signal of a present stage. A signal of a previous stage and/or a signal of a next stage may not be applied to the pixel circuit in FIGS. 9 and 10 so the “[N]” may not be provided in FIG. 10.

In one or more embodiments, the output signal OUT of the stage circuit of FIG. 4 may be the compensation gate signal GC applied to the third pixel switching element PT3.

A timing diagram of FIG. 11 may be substantially the same as the timing diagram of FIG. 10. In one or more embodiments, the data initialization gate signal GI, the compensation gate signal GC and the light-emitting element initialization gate signal GB may be provided by (e.g., generated from) the driver (e.g., the same driver). Thus, for brevity, substantially similar elements and/or functions are not described in detail again in reference to FIG. 11.

In FIG. 11, “[N]” may indicate a signal of a present stage, “[N−M]” may indicate a signal of an M-th previous stage and “[N+L]” may indicate a signal of an L-th next stage. Thus, the “[N]” for the signal of the present stage may not be provided.

In one or more embodiments, the output signal OUT of the stage circuit of FIG. 4 may be the compensation gate signal GC[N] applied to the third pixel switching element PT3, the data initialization gate signal GC[N−M] applied to the fourth pixel switching element PT4 and the light-emitting element initialization gate signal GC[N+L] applied to the seventh pixel switching element PT7.

As shown in FIG. 11, the data initialization gate signal GC[N−M] may have a timing before (e.g., earlier than) a timing of the compensation gate signal GC[N] in a frame. In one or more embodiments, the light-emitting element initialization gate signal GC[N+L] may have a timing after (e.g., later than) a timing of the compensation gate signal GC[N] in the frame.

In one or more embodiments, the voltage VGL2 may be increased from (e.g., greater than) the relatively low power voltage VGL and may be applied to the second electrode of the fourth transistor T4 which may be the NMOS transistor in the CMOS-type driver to operate the gate-source voltage of the fourth transistor T4 in a negative region.

In one or more embodiments, the second control electrode of the fourth transistor T4 may be connected to the control electrode of the fourth transistor T4.

The voltage VGL2 increased from (e.g., greater than) the relatively low power voltage VGL may be applied to the second electrode of the fourth transistor T4 which may be the NMOS transistor in the CMOS-type driver so that the current leakage of the fourth transistor T4 may be reduced. The current leakage of the fourth transistor T4 may be reduced so that the reliability of the CMOS-type driver may be enhanced and/or increased (as used herein, “reliability” may refer to “operational reliability”).

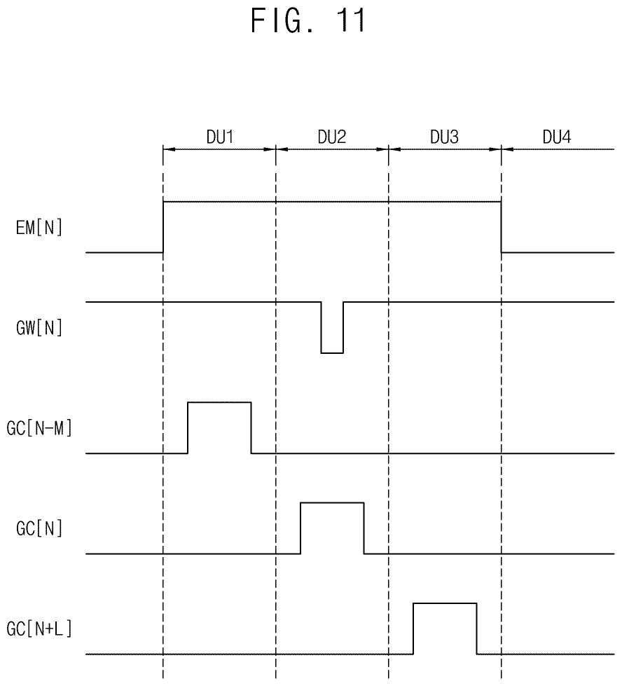

FIG. 12 is a circuit diagram illustrating a stage of a driver of a display apparatus according to one or more embodiments of the present disclosure.

The driver and the display apparatus may include the driver, according to one or more embodiments, and may be substantially the same as the driver and the display apparatus including the driver described referring to FIG. 1 to FIG. 11. In one or more embodiments, the relatively low power voltage may be applied to the second electrode of the fourth transistor and the driver further may include an eighth transistor. Thus, the same reference numerals may be used to refer to the same and/or like parts as those described in reference to FIG. 1 to FIG. 11. Thus, for brevity, substantially similar elements and/or functions are not described in detail again in reference to FIG. 12.

Referring to FIG. 1 to FIG. 3 and FIG. 6 to FIG. 12, the display apparatus may include a display panel 100 and/or a display panel driver. The display panel driver may include a driving controller 200, a gate driver 300, a gamma reference voltage generator 400, a data driver 500 and/or an emission driver 600.

For example, the driver may be the gate driver 300 outputting the gate signal in FIG. 2A. For example, the driver may be the emission driver 600 outputting the emission signal in FIG. 2B. As such, a driver circuit according to one or more embodiments of the present disclosure may be applied to the gate driver 300 and/or the emission driver 600.

The stage of the driver may include a CMOS-type driver including at least one PMOS transistor and/or at least one NMOS transistor.

The stage of the driver may include a first transistor T1, a second transistor T2, a third transistor T3, a fourth transistor T4, a fifth transistor T5 and/or a sixth transistor T6. The first transistor T1 may include a control electrode for receiving a first clock signal CLK1, a first electrode for receiving an input signal (a start signal FLM or an output signal of a previous stage) and a second electrode connected to a first node A. The second transistor T2 may include a control electrode connected to the first node A, a first electrode for receiving a relatively high power voltage VGH and a second electrode connected to a second node QB. The third transistor T3 may include a control electrode for receiving a relatively low power voltage VGL, a first electrode connected to the first node A and a second electrode connected to a third node Q. The fourth transistor T4 may include a control electrode connected to the first node A and a first electrode connected to the second node QB. The fifth transistor T5 may include a control electrode connected to the second node QB, a first electrode for receiving the relatively high power voltage VGH and a second electrode connected to an output node. The sixth transistor T6 may include a control electrode connected to the third node A, a first electrode connected to the output node and a second electrode for receiving the relatively low power voltage VGL. The fourth transistor T4 may be an NMOS transistor. A gate-source voltage of the fourth transistor T4 may be a determined value, for example less than zero volts.

For example, the first transistor T1, the second transistor T2, the third transistor T3, the fifth transistor T5 and/or the sixth transistor T6 may be PMOS transistors.

The fourth transistor T4 may further include a second control electrode connected to the control electrode of the fourth transistor T4. The fourth transistor T4 may further include the second control electrode which may be gate-synced so that a reliability of the fourth transistor T4 may be enhanced and/or increased.

In one or more embodiments, the fourth transistor T4 may further include a second electrode for receiving the relatively low power voltage VGL.

In one or more embodiments, the driver may further include the eighth transistor T8 including a control electrode connected to the third node Q and a first electrode connected to the first node A. The eighth transistor T8 may further include a second electrode for receiving a third relatively low power voltage VGL3 (e.g., referred to as a “fourth voltage” in the claims) that may be different from the relatively low power voltage VGL. Herein, the third relatively low power voltage VGL3 may be less than the relatively low power voltage VGL.

In one or more embodiments, the third low power voltage VGL3 may be applied to the control electrode of the fourth transistor T4 such that a gate-source voltage of the fourth transistor T4 may be a determined value, for example less than zero volts.

In one or more embodiments, if a relatively low level of the start signal FLM may be less than the relatively low power voltage VGL, a relatively low level of the first node A may go to a determined value (e.g., VGL+|VTH_T1|) and the gate-source voltage VGS_T4 of the fourth transistor T4 may go to a determined value (e.g., VGL+|VTH_T1|−VGL2). Herein, “|VTH_T1|” may refer to a threshold voltage of the first transistor T1.

In one or more embodiments, the second low power voltage VGL2 may be substantially equal to the relatively low power voltage VGL. If the first node A has a low level, the gate-source voltage VGS_T4 of the fourth transistor T4 may go to |VTH_T1| and the fourth transistor T4 may be turned on. If the first node A has a relatively low level, the second transistor T2 and/or the fourth transistor T4 may be turned on so that a current may be leaked through the second transistor T2 and/or the fourth transistor T4. Accordingly, an output defect of the driver may occur.

If the third low power voltage VGL3 is less than the relatively low power voltage VGL applied to the control electrode of the fourth transistor T4, the gate-source voltage VGS_T4 of the fourth transistor T4 may go to negative so that the fourth transistor T4 may be suitably (e.g., sufficiently) turned off.

Thus, if the third low power voltage VGL3 is set to be less than the low power voltage VGL, the reliability of the operation of the driver may be enhanced and/or increased.

In one or more embodiments, the voltage VGL3 may be less than the relatively low power voltage VGL applied to the control electrode of the fourth transistor T4 which may be the NMOS transistor in the CMOS-type driver to operate the gate-source voltage of the fourth transistor T4 in a negative region.

In one or more embodiments, the second control electrode of the fourth transistor T4 may be connected to the control electrode of the fourth transistor T4.

The voltage VGL3 may be less than the relatively low power voltage VGL applied to the control electrode of the fourth transistor T4 which may be the NMOS transistor in the CMOS-type driver so that the current leakage of the fourth transistor T4 may be reduced. The current leakage of the fourth transistor T4 may be reduced so that the reliability of the CMOS-type driver may be enhanced and/or increased.

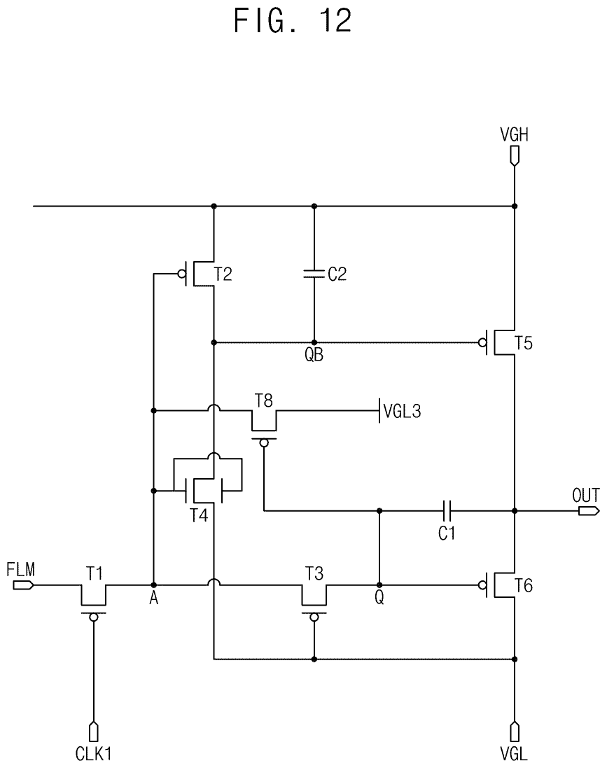

FIG. 13 is a circuit diagram illustrating a stage of a driver of a display apparatus according to one or more embodiments of the present disclosure.

The driver and the display apparatus including the driver according to one or more embodiments may be substantially the same as the driver and the display apparatus including the driver previously described referring to FIG. 1 to FIG. 11. In one or more embodiments, the relatively low power voltage may be applied to the second electrode of the fourth transistor and the driver may further include an eighth transistor. Thus, the same reference numerals may be used to refer to the same or like parts as those previously described in reference to FIG. 1 to FIG. 11. Thus, for brevity substantially similar elements and/or functions are not described in detail again in reference to FIG. 13.

Referring to FIG. 1 to FIG. 3, FIG. 6 to FIG. 11 and FIG. 13, the display apparatus may include a display panel 100 and/or a display panel driver. The display panel driver may include a driving controller 200, a gate driver 300, a gamma reference voltage generator 400, a data driver 500 and/or an emission driver 600.

For example, the driver may be the gate driver 300 outputting the gate signal in FIG. 2A. For example, the driver may be the emission driver 600 outputting the emission signal in FIG. 2B. As such, a driver circuit according to one or more embodiments of the present disclosure may be applied to the gate driver 300 and the emission driver 600.

The stage of the driver may include a CMOS-type driver including at least one PMOS transistor and/or at least one NMOS transistor.

The stage of the driver may include a first transistor T1, a second transistor T2, a third transistor T3, a fourth transistor T4, a fifth transistor T5 and/or a sixth transistor T6. The first transistor T1 may include a control electrode for receiving a first clock signal CLK1, a first electrode for receiving an input signal (a start signal FLM and/or an output signal of a previous stage) and a second electrode connected to a first node A. The second transistor T2 may include a control electrode connected to the first node A, a first electrode for receiving a high power voltage VGH and a second electrode connected to a second node QB. The third transistor T3 may include a control electrode for receiving a low power voltage VGL, a first electrode connected to the first node A and a second electrode connected to a third node Q. The fourth transistor T4 may include a control electrode connected to the first node A and a first electrode connected to the second node QB. The fifth transistor T5 may include a control electrode connected to the second node QB, a first electrode for receiving the high power voltage VGH and a second electrode connected to an output node. The sixth transistor T6 may include a control electrode connected to the third node A, a first electrode connected to the output node and a second electrode for receiving the relatively low power voltage VGL. The fourth transistor T4 may be an NMOS transistor. A gate-source voltage of the fourth transistor T4 may be a determined value, for example less than zero volts.

For example, the first transistor T1, the second transistor T2, the third transistor T3, the fifth transistor T5 and the sixth transistor T6 may be PMOS transistors.

The fourth transistor T4 may further include a second control electrode connected to the control electrode of the fourth transistor T4. The fourth transistor T4 may further include the second control electrode which may be gate-synced so that a reliability of the fourth transistor T4 may be enhanced and/or increased.

In one or more embodiments, the fourth transistor T4 may further include a second electrode for receiving the relatively low power voltage VGL.

In one or more embodiments, the driver may further include the eighth transistor T8 including a control electrode connected to the third node Q and a first electrode connected to the first node A. The eighth transistor T8 may further include a second electrode connected to the third node Q.

In one or more embodiments, a relatively low level (e.g., 2*VGL) of the signal of the third node Q may be applied to the control electrode of the fourth transistor T4 such that a gate-source voltage of the fourth transistor T4 may be a determined value, for example less than zero volts.

If a relatively low level of the start signal FLM is less than the relatively low power voltage VGL, a low level of the first node A may go to a determined value (e.g., VGL+|VTH_T1|) and the gate-source voltage VGS_T4 of the fourth transistor T4 may go to a determined value (e.g., VGL+|VTH_T1|−VGL2). Herein, “|VTH_T1|” may refer to a threshold voltage of the first transistor T1.

In one or more embodiments, the second relatively low power voltage VGL2 may be substantially equal to the relatively low power voltage VGL. If the first node A has a relatively low level, the gate-source voltage VGS_T4 of the fourth transistor T4 may go to the determined value (e.g., |VTH_T1|) and the fourth transistor T4 may be turned on. If the first node A has a relatively low level, the second transistor T2 and/or the fourth transistor T4 may be turned on so that a current may be leaked through the second transistor T2 and the fourth transistor T4. Accordingly, an output defect of the driver may occur.

In one or more embodiments, if the relatively low level (e.g., 2*VGL) of the signal of the third node Q is less than the relatively low power voltage VGL applied to the control electrode of the fourth transistor T4, the gate-source voltage VGS_T4 of the fourth transistor T4 may go to negative so that the fourth transistor T4 may be suitably (e.g., sufficiently) turned off.

Thus, if the third relatively low power voltage VGL3 may be set to be less than the relatively low power voltage VGL, the reliability of the operation of the driver may be enhanced and/or increased.

In one or more embodiments, the voltage (e.g., 2*VGL) may be less than the relatively low power voltage VGL applied to the control electrode of the fourth transistor T4, which may be the NMOS transistor in the CMOS-type driver to operate the gate-source voltage of the fourth transistor T4 in a negative region.

In one or more embodiments, the second control electrode of the fourth transistor T4 may be connected to the control electrode of the fourth transistor T4.

The voltage (e.g., 2*VGL) may be less than the relatively low power voltage VGL applied to the control electrode of the fourth transistor T4, which may be the NMOS transistor in the CMOS-type driver so that the current leakage of the fourth transistor T4 may be reduced. The current leakage of the fourth transistor T4 may be reduced so that the reliability of the CMOS-type driver may be enhanced and/or increased.

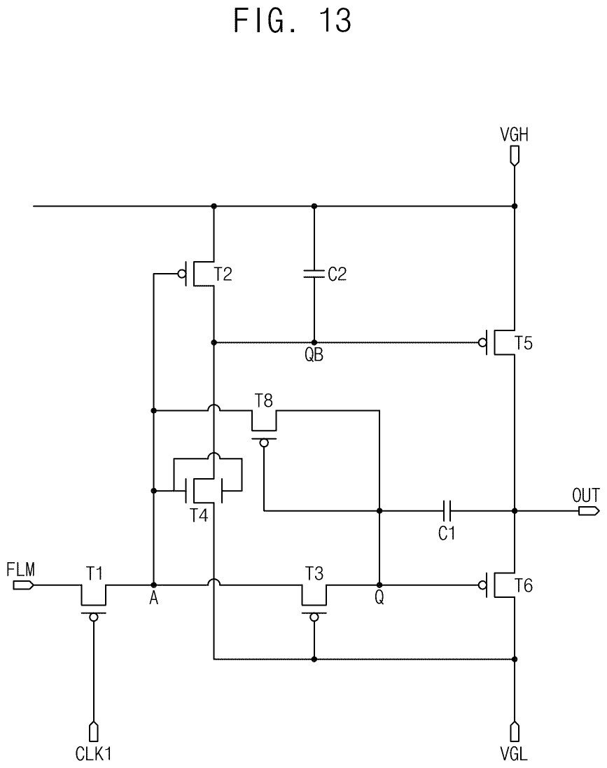

FIG. 14 is a circuit diagram illustrating a stage of a driver of a display apparatus according to one or more embodiments of the present disclosure.

The driver and the display apparatus including the driver according to one or more embodiments, may be substantially the same as the driver and the display apparatus including the driver previously described in referring to FIG. 1 to FIG. 11. In one or more embodiments, the driver may further include an eighth transistor. Thus, the same reference numerals may be used to refer to substantially the same or like parts as those previously described in reference to FIG. 1 to FIG. 11. Thus, for brevity substantially similar elements and/or functions are not described in detail again in reference to FIG. 14.

Referring to FIG. 1 to FIG. 3, FIG. 6 to FIG. 11 and FIG. 14, the display apparatus may include a display panel 100 and a display panel driver. The display panel driver may include a driving controller 200, a gate driver 300, a gamma reference voltage generator 400, a data driver 500 and/or an emission driver 600.

For example, the driver may be the gate driver 300 outputting the gate signal in FIG. 2A. For example, the driver may be the emission driver 600 outputting the emission signal in FIG. 2B. As such, a driver circuit according to one or more embodiments of the present disclosure may be applied to the gate driver 300 and/or the emission driver 600.

The stage of the driver may include a CMOS-type driver including at least one PMOS transistor and/or at least one NMOS transistor.

The stage of the driver may include a first transistor T1, a second transistor T2, a third transistor T3, a fourth transistor T4, a fifth transistor T5 and/or a sixth transistor T6. The first transistor T1 may include a control electrode for receiving a first clock signal CLK1, a first electrode for receiving an input signal (a start signal FLM and/or an output signal of a previous stage) and a second electrode connected to a first node A. The second transistor T2 may include a control electrode connected to the first node A, a first electrode for receiving a high power voltage VGH and a second electrode connected to a second node QB. The third transistor T3 may include a control electrode for receiving a relatively low power voltage VGL, a first electrode connected to the first node A and a second electrode connected to a third node Q. The fourth transistor T4 may include a control electrode connected to the first node A and a first electrode connected to the second node QB. The fifth transistor T5 may include a control electrode connected to the second node QB, a first electrode for receiving the relatively high power voltage VGH and a second electrode connected to an output node. The sixth transistor T6 may include a control electrode connected to the third node A, a first electrode connected to the output node and a second electrode for receiving the relatively low power voltage VGL. The fourth transistor T4 may be an NMOS transistor. A gate-source voltage of the fourth transistor T4 may be a determined value, for example less than zero volts.

For example, the first transistor T1, the second transistor T2, the third transistor T3, the fifth transistor T5 and/or the sixth transistor T6 may be PMOS transistors.

The fourth transistor T4 may further include a second control electrode connected to the control electrode of the fourth transistor T4. The fourth transistor T4 may further include the second control electrode which may be gate-synced so that a reliability of the fourth transistor T4 may be enhanced and/or increased.

In one or more embodiments, the fourth transistor T4 may further include a second electrode for receiving a second relatively low power voltage VGL2 that may be different from the relatively low power voltage VGL. Herein, the second relatively low power voltage VGL2 may be greater (e.g., higher) than the relatively low power voltage VGL.

In one or more embodiments, the driver may further include the eighth transistor T8 including a control electrode connected to the third node Q and a first electrode connected to the first node A. The eighth transistor T8 may further include a second electrode for receiving a third relatively low power voltage VGL3 that may be different from the relatively low power voltage VGL. Herein, the third relatively low power voltage VGL3 may be less than the relatively low power voltage VGL.

In one or more embodiments, the second relatively low power voltage VGL2 may be applied to the second electrode of the fourth transistor T4 and the third relatively low power voltage VGL3 may be applied to the control electrode of the fourth transistor T4 such that a gate-source voltage of the fourth transistor T4 may be less than a determined value, for example zero volts.

In one or more embodiments, the voltage VGL2 may be greater (e.g., higher) than the relatively low power voltage VGL applied to the second electrode of the fourth transistor T4, which may be the NMOS transistor in the CMOS-type driver and the voltage VGL3 may be less than the relatively low power voltage VGL applied to the control electrode of the fourth transistor T4 to operate the gate-source voltage of the fourth transistor T4 in a negative region.

In one or more embodiments, the second control electrode of the fourth transistor T4 may be connected to the control electrode of the fourth transistor T4.

The voltage VGL2 may be greater (e.g., higher) than the relatively low power voltage VGL that may be applied to the second electrode of the fourth transistor T4, which may be the NMOS transistor in the CMOS-type driver and the voltage VGL3 may be less than the relatively low power voltage VGL that may be applied to the control electrode of the fourth transistor T4 so that the current leakage of the fourth transistor T4 may be reduced. The current leakage of the fourth transistor T4 may be reduced so that the reliability of the CMOS-type driver may be enhanced and/or increased.

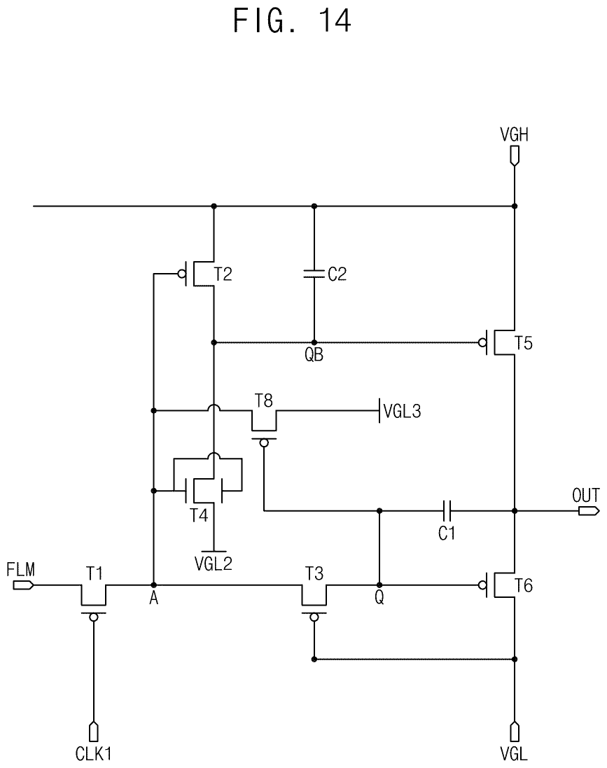

FIG. 15 is a circuit diagram illustrating a stage of a driver of a display apparatus according to one or more embodiments of the present disclosure.

The driver and the display apparatus including the driver according to one or more embodiments may be substantially the same as the driver and the display apparatus including the driver previously described referring to FIG. 1 to FIG. 11. In one or more embodiments, the driver may further include an eighth transistor. Thus, the same reference numerals may be used to refer to the substantially same or like parts as those previously described in reference to FIG. 1 to FIG. 11. Thus, for brevity substantially similar elements and/or functions are not described in detail again in reference to FIG. 15.

Referring to FIG. 1 to FIG. 3, FIG. 6 to FIG. 11 and FIG. 15, the display apparatus may include a display panel 100 and/or a display panel driver. The display panel driver may include a driving controller 200, a gate driver 300, a gamma reference voltage generator 400, a data driver 500 and/or an emission driver 600.

For example, the driver may be the gate driver 300 outputting the gate signal in FIG. 2A. For example, the driver may be the emission driver 600 outputting the emission signal in FIG. 2B. As such, a driver circuit according to one or more embodiments of the present disclosure may be applied to the gate driver 300 and/or the emission driver 600.

The stage of the driver may include a CMOS-type driver including at least one PMOS transistor and/or at least one NMOS transistor.

The stage of the driver may include a first transistor T1, a second transistor T2, a third transistor T3, a fourth transistor T4, a fifth transistor T5 and a sixth transistor T6. The first transistor T1 may include a control electrode for receiving a first clock signal CLK1, a first electrode for receiving an input signal (a start signal FLM and/or an output signal of a previous stage) and a second electrode connected to a first node A. The second transistor T2 may include a control electrode connected to the first node A, a first electrode for receiving a high power voltage VGH and a second electrode connected to a second node QB. The third transistor T3 may include a control electrode for receiving a low power voltage VGL, a first electrode connected to the first node A and a second electrode connected to a third node Q. The fourth transistor T4 may include a control electrode connected to the first node A and a first electrode connected to the second node QB. The fifth transistor T5 may include a control electrode connected to the second node QB, a first electrode for receiving the high power voltage VGH and a second electrode connected to an output node. The sixth transistor T6 may include a control electrode connected to the third node A, a first electrode connected to the output node and a second electrode for receiving the relatively low power voltage VGL. The fourth transistor T4 may be an NMOS transistor. A gate-source voltage of the fourth transistor T4 may be a determined value, for example less than zero volts.

For example, the first transistor T1, the second transistor T2, the third transistor T3, the fifth transistor T5 and/or the sixth transistor T6 may be PMOS transistors.

The fourth transistor T4 may further include a second control electrode connected to the control electrode of the fourth transistor T4. The fourth transistor T4 may further include the second control electrode which may be gate-synced so that a reliability of the fourth transistor T4 may be enhanced and/or increased.

In one or more embodiments, the fourth transistor T4 may further include a second electrode for receiving a second relatively low power voltage VGL2 that may be different from the relatively low power voltage VGL. Herein, the second relatively low power voltage VGL2 may be greater (e.g., higher) than the relatively low power voltage VGL.

In one or more embodiments, the driver may further include the eighth transistor T8 including a control electrode connected to the third node Q and a first electrode connected to the first node A. The eighth transistor T8 may further include a second electrode connected to the third node Q.

In one or more embodiments, the relatively second low power voltage VGL2 may be applied to the second electrode of the fourth transistor T4 and/or a relatively low level (e.g., 2*VGL) of the signal of the third node Q may be applied to the control electrode of the fourth transistor T4 such that a gate-source voltage of the fourth transistor T4 may be a determined value, for example less than zero volts.

In one or more embodiments, the second relatively low power voltage VGL2 may be applied to the second electrode of the fourth transistor T4 which may be the NMOS transistor in the CMOS-type driver and the voltage (e.g., 2*VGL) may be less than the relatively low power voltage VGL that may be applied to the control electrode of the fourth transistor T4 to operate the gate-source voltage of the fourth transistor T4 in a negative region.

In one or more embodiments, the second control electrode of the fourth transistor T4 may be connected to the control electrode of the fourth transistor T4.

The second relatively low power voltage VGL2 may be applied to the second electrode of the fourth transistor T4 which may be the NMOS transistor in the CMOS-type driver, and the voltage (e.g., 2*VGL) may be less than the relatively low power voltage VGL that may be applied to the control electrode of the fourth transistor T4 so that the current leakage of the fourth transistor T4 may be reduced. The current leakage of the fourth transistor T4 may be reduced so that the reliability of the CMOS type driver may be enhanced and/or increased.

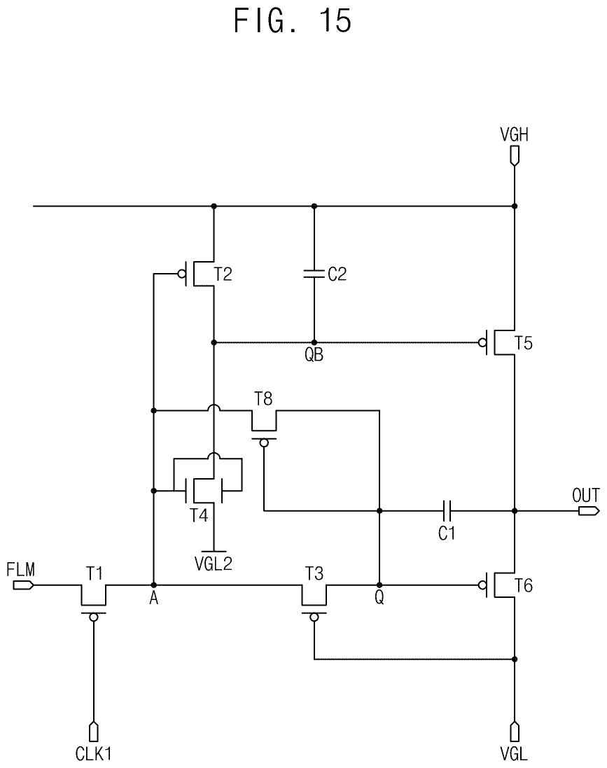

FIG. 16 is a circuit diagram illustrating a stage of a driver of a display apparatus according to one or more embodiments of the present disclosure.

The driver and the display apparatus including the driver according to one or more embodiments may be substantially the same as the driver and/or the display apparatus including the driver previously described referring to FIG. 1 to FIG. 11. In one or more embodiments, one or more of (e.g., each of) the first transistor, the second transistor, the third transistor, the fifth transistor and/or the sixth transistor of the driver of the display apparatus may further include a second control electrode. Thus, the same reference numerals may be used to refer to the substantially same and/or like parts as those previously described in reference to FIG. 1 to FIG. 11. Thus, for brevity substantially similar elements and/or functions are not described in detail again in reference to FIG. 16.

Referring to FIG. 1 to FIG. 3 and FIG. 6 to FIG. 11 and FIG. 16, the display apparatus may include a display panel 100 and/or a display panel driver. The display panel driver may include a driving controller 200, a gate driver 300, a gamma reference voltage generator 400, a data driver 500 and/or an emission driver 600.

For example, the driver may be the gate driver 300 outputting the gate signal in FIG. 2A. For example, the driver may be the emission driver 600 outputting the emission signal in FIG. 2B. As such, a driver circuit according to one or more embodiments of the present disclosure may be applied to the gate driver 300 and/or the emission driver 600.

The stage of the driver may include a CMOS-type driver including at least one PMOS transistor and/or at least one NMOS transistor.

The stage of the driver may include a first transistor T1, a second transistor T2, a third transistor T3, a fourth transistor T4, a fifth transistor T5 and/or a sixth transistor T6. The first transistor T1 may include a control electrode for receiving a first clock signal CLK1, a first electrode for receiving an input signal (a start signal FLM or an output signal of a previous stage) and a second electrode connected to a first node A. The second transistor T2 may include a control electrode connected to the first node A, a first electrode for receiving a relatively high power voltage VGH and a second electrode connected to a second node QB. The third transistor T3 may include a control electrode for receiving a relatively low power voltage VGL, a first electrode connected to the first node A and a second electrode connected to a third node Q. The fourth transistor T4 may include a control electrode connected to the first node A and a first electrode connected to the second node QB. The fifth transistor T5 may include a control electrode connected to the second node QB, a first electrode for receiving the relatively high power voltage VGH and a second electrode connected to an output node. The sixth transistor T6 may include a control electrode connected to the third node A, a first electrode connected to the output node and a second electrode for receiving the relatively low power voltage VGL. The fourth transistor T4 may be an NMOS transistor. A gate-source voltage of the fourth transistor T4 may be a determined value, for example less than zero volts.

In one or more embodiments, the first transistor T1 may further include a second control electrode connected to the control electrode of the first transistor T1. The second transistor T2 may further include a second control electrode connected to the control electrode of the second transistor T2. The third transistor T3 may further include a second control electrode connected to the control electrode of the third transistor T3. The fifth transistor T5 may further include a second control electrode connected to the control electrode of the fifth transistor T5. The sixth transistor T6 may further include a second control electrode connected to the control electrode of the sixth transistor T6.

The first transistor T1, the second transistor T2, the third transistor T3, the fifth transistor T5 and/or the sixth transistor T6 may further include the second control electrodes which may be gate-synced so that reliability of the first transistor T1, the second transistor T2, the third transistor T3, the fifth transistor T5 and/or the sixth transistor T6 may be enhanced and/or increased.

The gate-synced structures of the first transistor T1, the second transistor T2, the third transistor T3, the fifth transistor T5 and/or the sixth transistor T6 may be applied to the circuit diagram of FIG. 4, for example, in one or more embodiments (e.g., see FIG. 16). The gate-synced structures of the first transistor T1, the second transistor T2, the third transistor T3, the fifth transistor T5 and/or the sixth transistor T6 may be applied to the circuit diagrams of FIG. 12 to FIG. 18, in one or more embodiments.

In one or more embodiments, the eighth transistor T8 may further include a second control electrode connected to the control electrode of the eighth transistor T8 in the circuit diagrams of FIG. 12 to FIG. 15.

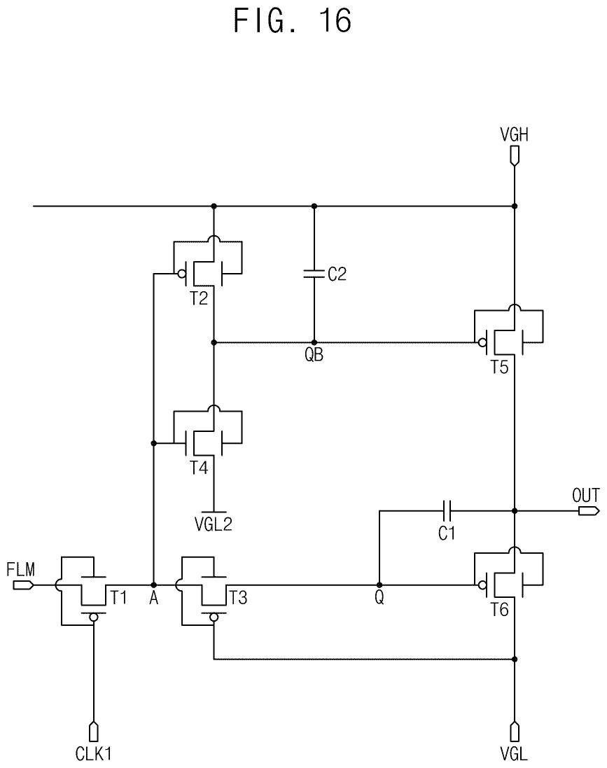

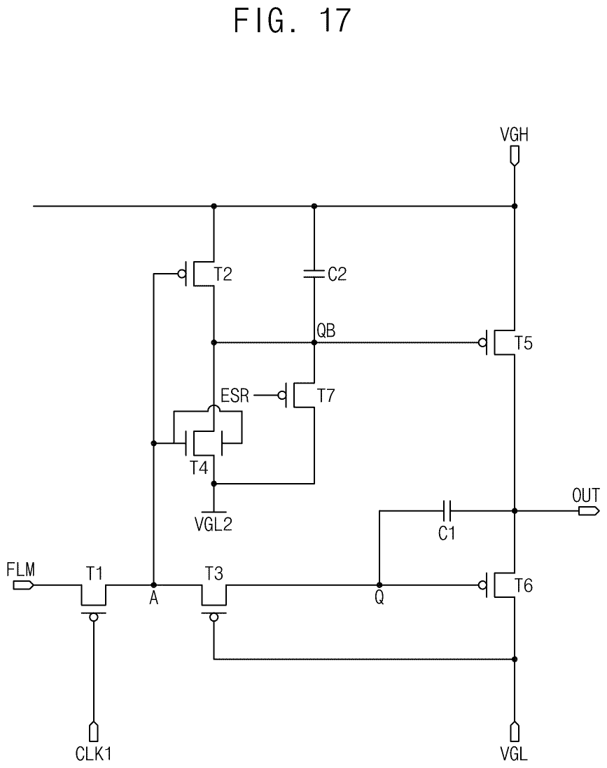

In one or more embodiments, a seventh transistor T7 may further include a second control electrode connected to a control electrode of the seventh transistor T7 in the circuit diagrams of FIG. 17 and FIG. 18.

In one or more embodiments, the voltage VGL2 may be greater (e.g., higher) than the relatively low power voltage VGL that may be applied to the second electrode of the fourth transistor T4, which may be the NMOS transistor in the CMOS-type driver or the voltage (e.g., VGL3 and/or 2*VGL) may be less than the relatively low power voltage VGL that may be applied to the control electrode of the fourth transistor T4 to operate the gate-source voltage of the fourth transistor T4 in a negative region.

In one or more embodiments, the second control electrode of the fourth transistor T4 may be connected to the control electrode of the fourth transistor T4.

The voltage VGL2 may be greater (e.g., higher) than the low power voltage VGL that may be applied to the second electrode of the fourth transistor T4, which may be the NMOS transistor in the CMOS-type driver, and/or or the voltage (e.g., VGL3 and/or 2*VGL) may be less than the relatively low power voltage VGL that may be applied to the control electrode of the fourth transistor T4 so that the current leakage of the fourth transistor T4 may be reduced. The current leakage of the fourth transistor T4 may be reduced so that the reliability of the CMOS-type driver may be enhanced and/or increased.

FIG. 17 is a circuit diagram illustrating a stage of a driver of a display apparatus according to one or more embodiments of the present disclosure.

The driver and/or the display apparatus including the driver in the example of FIG. 17 may be substantially the same as the driver and/or the display apparatus including the driver previously described referring to FIG. 1 to FIG. 11. In one or more embodiments, the driver may further include a seventh transistor for resetting the stage, as illustrated in FIG. 17. Thus, the same reference numerals may be used to refer to the same and/or like parts as those previously described in reference to FIG. 1 to FIG. 11. Thus, for brevity substantially similar elements and/or functions are not described in detail again in reference to FIG. 17.

Referring to FIG. 1 to FIG. 3 and FIG. 6 to FIG. 11 and FIG. 17, the display apparatus may include a display panel 100 and/or a display panel driver. The display panel driver includes a driving controller 200, a gate driver 300, a gamma reference voltage generator 400, a data driver 500 and/or an emission driver 600.

For example, the driver may be the gate driver 300 outputting the gate signal in FIG. 2A. For example, the driver may be the emission driver 600 outputting the emission signal in FIG. 2B. As such, a driver circuit according to one or more embodiments may be applied to the gate driver 300 and/or the emission driver 600.

The stage of the driver may include a CMOS type driver including at least one PMOS transistor and/or at least one NMOS transistor.

The stage of the driver may include a first transistor T1, a second transistor T2, a third transistor T3, a fourth transistor T4, a fifth transistor T5 and/or a sixth transistor T6. The first transistor T1 may include a control electrode for receiving a first clock signal CLK1, a first electrode for receiving an input signal (a start signal FLM or an output signal of a previous stage) and a second electrode connected to a first node A. The second transistor T2 may include a control electrode connected to the first node A, a first electrode for receiving a relatively high power voltage VGH and a second electrode connected to a second node QB. The third transistor T3 may include a control electrode for receiving a relatively low power voltage VGL, a first electrode connected to the first node A and a second electrode connected to a third node Q. The fourth transistor T4 may include a control electrode connected to the first node A and a first electrode connected to the second node QB. The fifth transistor T5 may include a control electrode connected to the second node QB, a first electrode for receiving the relatively high power voltage VGH and a second electrode connected to an output node. The sixth transistor T6 may include a control electrode connected to the third node A, a first electrode connected to the output node and a second electrode for receiving the relatively low power voltage VGL. The fourth transistor T4 may be an NMOS transistor. A gate-source voltage of the fourth transistor T4 may be a determined value, for example less than zero volts.

In one or more embodiments, the driver may further include a seventh transistor T7 including a control electrode for receiving a reset signal ESR, a first electrode connected to the second node QB and a second electrode connected to the second electrode of the fourth transistor T4.

For example, the stages of the driver may reset the second node QB to the relatively second low power voltage VGL2 based on an active level of the reset signal ESR that may be applied in an initial driving time.

If the second node QB is reset to the second relatively low power voltage VGL2, the reliability of the driver may be enhanced and/or increased.

In one or more embodiments, the seventh transistor T7 may be added to the circuit diagram of FIG. 4 as illustrated in FIG. 17. One or more embodiments of the present disclosure may not be limited thereto. The seventh transistor T7 may be added to the circuit diagrams of FIG. 12 to FIG. 16.

The second node QB may be reset to the second relatively low power voltage VGL2 in the circuit diagrams of FIG. 14 to FIG. 16. In one or more embodiments, the second node QB may reset the relatively low power voltage VGL in the circuit diagrams of FIG. 12 and FIG. 13.

In one or more embodiments, the voltage VGL2 may be greater (e.g., higher) than the relatively low power voltage VGL that may be applied to the second electrode of the fourth transistor T4, which may be the NMOS transistor in the CMOS-type driver, and/or the voltage (e.g., VGL3 and/or 2*VGL) may be less than the relatively low power voltage VGL that may be applied to the control electrode of the fourth transistor T4 to operate the gate-source voltage of the fourth transistor T4 in a negative region.

In one or more embodiments, the second control electrode of the fourth transistor T4 may be connected to the control electrode of the fourth transistor T4.

The voltage VGL2 may be greater (e.g., higher) than the relatively low power voltage VGL that may be applied to the second electrode of the fourth transistor T4 which may be the NMOS transistor in the CMOS-type driver, and/or the voltage (e.g., VGL3 or 2*VGL) may be less than the relatively low power voltage VGL that may be applied to the control electrode of the fourth transistor T4 so that the current leakage of the fourth transistor T4 may be reduced. The current leakage of the fourth transistor T4 may be reduced so that the reliability of the CMOS type driver may be enhanced and/or increased.

FIG. 18 is a circuit diagram illustrating a stage of a driver of a display apparatus according to one or more embodiments of the present disclosure.

The driver and/or the display apparatus including the driver according to one or more embodiments illustrated in FIG. 18 may be substantially the same as the driver and/or the display apparatus including the driver previously described referring to FIG. 1 to FIG. 11. In one or more embodiments, the driver may further include a seventh transistor for resetting the stage as illustrated in FIG. 18. Thus, the same reference numerals may be used to refer to the substantially same and/or like parts as those previously described in reference to FIG. 1 to FIG. 11. Thus, for brevity substantially similar elements and/or functions are not described in detail again in reference to FIG. 17.

Referring to FIG. 1 to FIG. 3, FIG. 6 to FIG. 11, and FIG. 18, the display apparatus may include a display panel 100 and/or a display panel driver. The display panel driver may include a driving controller 200, a gate driver 300, a gamma reference voltage generator 400, a data driver 500 and/or an emission driver 600.

For example, the driver may be the gate driver 300 outputting the gate signal in FIG. 2A. For example, the driver may be the emission driver 600 outputting the emission signal in FIG. 2B. As such, a driver circuit in one or more embodiments of the present disclosure may be applied to the gate driver 300 and/or the emission driver 600.

The stage of the driver may include a CMOS type driver including at least one PMOS transistor and/or at least one NMOS transistor.

The stage of the driver may include a first transistor T1, a second transistor T2, a third transistor T3, a fourth transistor T4, a fifth transistor T5 and/or a sixth transistor T6. The first transistor T1 may include a control electrode for receiving a first clock signal CLK1, a first electrode for receiving an input signal (a start signal FLM or an output signal of a previous stage) and a second electrode connected to a first node A. The second transistor T2 may include a control electrode connected to the first node A, a first electrode for receiving a relatively high power voltage VGH and a second electrode connected to a second node QB. The third transistor T3 may include a control electrode for receiving a low power voltage VGL, a first electrode connected to the first node A and a second electrode connected to a third node Q. The fourth transistor T4 may include a control electrode connected to the first node A and a first electrode connected to the second node QB. The fifth transistor T5 may include a control electrode connected to the second node QB, a first electrode for receiving the relatively high power voltage VGH and a second electrode connected to an output node. The sixth transistor T6 may include a control electrode connected to the third node A, a first electrode connected to the output node and a second electrode for receiving the relatively low power voltage VGL. The fourth transistor T4 may be an NMOS transistor. A gate-source voltage of the fourth transistor T4 may be a determined value, for example less than zero volts.

In one or more embodiments, the driver may further include a seventh transistor T7 including a control electrode for receiving a reset signal ESR, a first electrode for receiving the high power voltage VGH and a second electrode connected to the first node A.

For example, the stages of the driver may reset the first node A to the relatively high power voltage VGH based on an active level of the reset signal ESR that may be applied in an initial driving time.

If the first node A is reset to the relatively high power voltage VGH, the reliability of the driver may be enhanced and/or increased.

In one or more embodiments, the seventh transistor T7 may be added to the circuit diagram of FIG. 4, as illustrated in FIG. 18. One or more embodiments of the present disclosure may not be limited thereto. The seventh transistor T7 may be added to the circuit diagrams of FIG. 12 to FIG. 16, in one or more embodiments.

In one or more embodiments, as depicted in FIG. 18 for example, the voltage VGL2 may be greater (e.g., higher) than the low power voltage VGL that may be applied to the second electrode of the fourth transistor T4 which may be the NMOS transistor in the CMOS-type driver, and/or the voltage (e.g., VGL3 or 2*VGL) may be less than the relatively low power voltage VGL that may be applied to the control electrode of the fourth transistor T4 to operate the gate-source voltage of the fourth transistor T4 in a negative region.

In one or more embodiments, the second control electrode of the fourth transistor T4 may be connected to the control electrode of the fourth transistor T4.

The voltage VGL2 may be greater (e.g., higher) than the low power voltage VGL that may be applied to the second electrode of the fourth transistor T4 which may be the NMOS transistor in the CMOS-type driver or the voltage (e.g., VGL3 and/or 2*VGL) less than the low power voltage VGL that may be applied to the control electrode of the fourth transistor T4 so that the current leakage of the fourth transistor T4 may be reduced. The current leakage of the fourth transistor T4 may be reduced so that the reliability of the CMOS-type driver may be enhanced and/or increased.

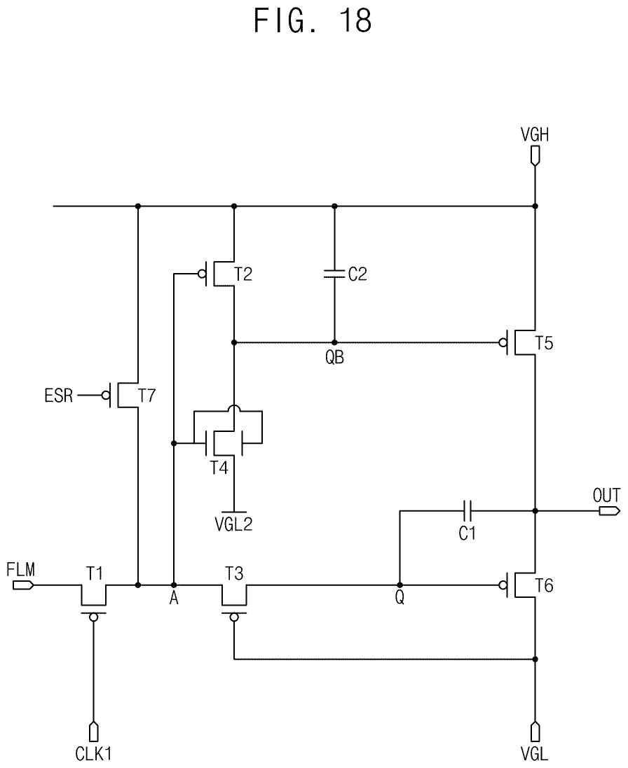

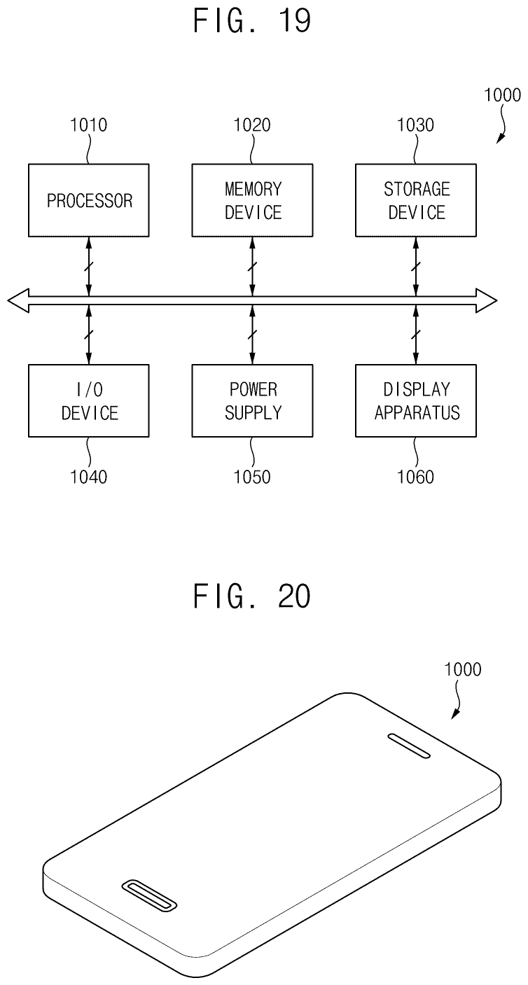

FIG. 19 is a block diagram illustrating an electronic apparatus 1000 according to one or more embodiments of the present disclosure. FIG. 20 is a diagram illustrating an example in which the electronic apparatus 1000 of FIG. 19 may be implemented as a smart phone.

Referring to FIGS. 1 to 20, the electronic apparatus 1000 may include a processor 1010, a memory device 1020, a storage device 1030, an input/output (I/O) device 1040, a power supply 1050 and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, and/or the like.

In one or more embodiments, as illustrated in FIG. 20, the electronic apparatus 1000 may be implemented as a smart phone. However, the electronic apparatus 1000 is not limited thereto. For example, the electronic apparatus 1000 may be implemented as a cellular phone, a video phone, a smart pad, a smart watch, a tablet PC, a car navigation system, a computer monitor, a laptop, a head-mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, and/or the like. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

In or more embodiments, the driver, the display apparatus including the driver and/or the electronic apparatus including the driver of one or more embodiments of the present disclosure, as explained above, the reliability of the driver may be enhanced and/or increased.

The foregoing is illustrative of the present disclosure and is not to be construed as limiting thereof. Although one or more example embodiments of the present disclosure have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific example embodiments disclosed, and that modifications to the disclosed example embodiments, as well as other example embodiments, are intended to be included within the scope of the appended claims. The present disclosure is defined by the following claims, with equivalents of the claims to be included therein.

What is claimed is:

1. A driver comprising:
a first transistor comprising a control electrode configured to receive a clock signal, a first electrode configured to receive an input signal, and a second electrode connected to a first node;
a second transistor comprising a control electrode connected to the first node, a first electrode configured to receive a first voltage, and a second electrode connected to a second node;
a third transistor comprising a control electrode configured to receive a second voltage, a first electrode connected to the first node, and a second electrode connected to a third node;
a fourth transistor comprising an NMOS transistor comprising a control electrode connected to the first node, and a first electrode connected to the second node, and configured to have a gate-source voltage that is less than zero;
a fifth transistor comprising a control electrode connected to the second node, a first electrode configured to receive the first voltage, and a second electrode connected to an output node; and
a sixth transistor comprising a control electrode connected to the third node, a first electrode connected to the output node, and a second electrode configured to receive the second voltage.

2. The driver of claim 1, further comprising a first capacitor comprising a first electrode connected to the third node, and a second electrode connected to the output node.

3. The driver of claim 1, further comprising a second capacitor comprising a first electrode configured to receive the first voltage, and a second electrode connected to the second node, wherein the first voltage comprises a high power voltage.

4. The driver of claim 1, wherein the first transistor, the second transistor, the third transistor, the fifth transistor, and the sixth transistor comprise PMOS transistors.

5. The driver of claim 1, wherein the fourth transistor further comprises a second control electrode connected to the control electrode of the fourth transistor.

6. The driver of claim 1, wherein the fourth transistor further comprises a second electrode configured to receive a third voltage,
wherein the second voltage comprises a low power voltage, and
wherein the third voltage comprises another low power voltage that is different from the second voltage.

7. The driver of claim 6, wherein the third voltage is greater than the second voltage.

8. The driver of claim 1, further comprising an eighth transistor comprising a control electrode connected to the third node, and a first electrode connected to the first node,
wherein the fourth transistor further comprises a second electrode configured to receive the second voltage.

9. The driver of claim 8, wherein the eighth transistor further comprises a second electrode configured to receive a fourth voltage,
wherein the second voltage comprises a low power voltage, and
wherein the fourth voltage comprises another low power voltage that is different from the second voltage.

10. The driver of claim 9, wherein the fourth voltage is less than the second voltage.

11. The driver of claim 8, wherein the eighth transistor further comprises a second electrode connected to the third node.

12. The driver of claim 1, further comprising an eighth transistor comprising a control electrode connected to the third node, and a first electrode connected to the first node,
wherein the fourth transistor further comprises a second electrode configured to receive a third voltage comprising a low power voltage that is different from the second voltage.

13. The driver of claim 12, wherein the eighth transistor further comprises a second electrode configured to receive a fourth voltage comprising another low power voltage that is different from the second voltage.

14. The driver of claim 13, wherein the third voltage is greater than the second voltage, and
wherein the fourth voltage is less than the second voltage.

15. The driver of claim 12, wherein the eighth transistor further comprises a second electrode connected to the third node.

16. The driver of claim 1, wherein the first transistor further comprises a second control electrode connected to the control electrode of the first transistor,
wherein the second transistor further comprises a second control electrode connected to the control electrode of the second transistor,
wherein the third transistor further comprises a second control electrode connected to the control electrode of the third transistor,
wherein the fifth transistor further comprises a second control electrode connected to the control electrode of the fifth transistor, and
wherein the sixth transistor further comprise a second control electrode connected to the control electrode of the sixth transistor.

17. The driver of claim 1, further comprising a seventh transistor comprising a control electrode configured to receive a reset signal, a first electrode connected to the second node, and a second electrode connected to a second electrode of the fourth transistor.

18. The driver of claim 1, further comprising a seventh transistor comprising a control electrode configured to receive a reset signal, a first electrode configured to receive the first voltage, and a second electrode connected to the first node.

19. A display apparatus, comprising:
a display panel comprising a pixel;
a gate driver configured to output a gate signal to the pixel;
a data driver configured to output a data voltage to the pixel; and
an emission driver configured to output an emission signal to the pixel,
wherein the gate driver or the emission driver comprises at least one stage comprising:
a first transistor comprising a control electrode configured to receive a clock signal, a first electrode configured to receive an input signal, and a second electrode connected to a first node;
a second transistor comprising a control electrode connected to the first node, a first electrode configured to receive a first voltage, and a second electrode connected to a second node;
a third transistor comprising a control electrode configured to receive a second voltage, a first electrode connected to the first node, and a second electrode connected to a third node;
a fourth transistor comprising an NMOS transistor comprising a control electrode connected to the first node, and a first electrode connected to the second node, and configured to have a gate-source voltage that is less than zero;
a fifth transistor comprising a control electrode connected to the second node, a first electrode configured to receive the first voltage, and a second electrode connected to an output node; and
a sixth transistor comprising a control electrode connected to the third node, a first electrode connected to the output node, and a second electrode configured to receive the second voltage.

20. An electronic apparatus, comprising:
a display panel comprising a pixel;
a gate driver configured to output a gate signal to the pixel;
a data driver configured to output a data voltage to the pixel;
an emission driver configured to output an emission signal to the pixel;
a driving controller configured to control the gate driver, the data driver, and the emission driver; and
a processor configured to output image data and a control signal to the driving controller,
wherein the gate driver or the emission driver comprises at least one stage comprising:
a first transistor comprising a control electrode configured to receive a clock signal, a first electrode configured to receive an input signal, and a second electrode connected to a first node;
a second transistor comprising a control electrode connected to the first node, a first electrode configured to receive a first voltage, and a second electrode connected to a second node;
a third transistor comprising a control electrode configured to receive a second voltage, a first electrode connected to the first node, and a second electrode connected to a third node;
a fourth transistor comprising an NMOS transistor comprising a control electrode connected to the first node, and a first electrode connected to the second node, and configured to have a gate-source voltage that is less than zero;
a fifth transistor comprising a control electrode connected to the second node, a first electrode configured to receive the first voltage, and a second electrode connected to an output node; and
a sixth transistor comprising a control electrode connected to the third node, a first electrode connected to the output node, and a second electrode configured to receive the second voltage.
